(19) United States
(12) Patent Application Publication
(10) Pub. No.: US 2026/0339092 A1
(43) Pub. Date: Oct. 29, 2026

(54) OBJECTIVE

(71) Applicant: Evident Corporation, Tatsuno-machi (JP)

(72) Inventors: Naofumi MIDORIKAWA, Kamiina-gun (JP); Kenichiro ABE, Kamiina-gun (JP)

(73) Assignee: Evident Corporation, Tatsuno-machi (JP)

(21) Appl. No.: 19/552,869

(22) Filed: Feb. 27, 2026

(30) Foreign Application Priority Data
Apr. 25, 2025 (JP) 2025-073151

(51) Int. Cl. G02B 21/33; G02B 21/02

(52) U.S. Cl. CPC G02B 21/33; G02B 21/02

(57) ABSTRACT

An objective includes a first lens group having positive power, a second lens group moving along an optical axis and having positive power, and third and fourth lens groups arranged so that concave surfaces adjacent to each other face each other. The third lens group includes a lens group M including at least two each of positive and negative lenses, wherein adjacent lenses are cemented; or adjacent lenses are separated by an air layer and satisfy following conditional expressions. Here, R1 and R2 denote curvature radiuses of lens surfaces on the object side and on the image side of the air layer, respectively, d denotes a thickness of the air layer, and t1 and t2 denote thicknesses of lens components on the object side and on the image side of the air layer, respectively:

0≤|1/R1−1/R2|×(t1+t2)≤0.8

0≤d/(t1+t2)≤0.2.

### CROSS-REFERENCE TO RELATED APPLICATION

This application is based upon and claims the benefit of priority from prior Japanese Patent Application No. 2025-073151 filed Apr. 25, 2025, the entire contents of which are incorporated herein by this reference.

### FIELD

The disclosure of the present specification relates to an objective.

### BACKGROUND

In recent years, there is significant increase in the number of pixels of imaging elements, and in the field of microscopes, expectations for microscope devices that achieve both a wide field of view and high resolution and that are capable of performing observation and image acquisition have grown. In addition, since the cell-cell interactions and migration can be observed in a state closer to that of tissue in a living body, research on three-dimensional structures such as spheroids has increased in recent years. As a result, expectations for microscope devices capable of deep observation in a living body are also increasing. For these reasons, an objective having a long focal length, a low magnification, a high numerical aperture (hereinafter referred to as NA), and a long working distance (hereinafter referred to as WD) is desired.

On the other hand, when an objective having a high NA is used for the deep observation in a living body, spherical aberration significantly changes with respect to a change in refractive index of a specimen or an immersion liquid. Therefore, in order to correct the change of the spherical aberration, it is desirable to have a mechanism that moves a lens component in the objective along an optical axis. Such an objective is described, for example, in U.S. Pat. No. 10,732,395 B2.

### SUMMARY

An objective according to one aspect of the present invention includes: in order from an object side, a first lens group that has positive refractive power; a second lens group that is moved along an optical axis and has positive refractive power; and a third lens group and a fourth lens group arranged so that concave surfaces adjacent to each other face each other. The third lens group includes a lens group M including two or more positive lenses and two or more negative lenses in which a lens surface closest to the object side is a convex surface facing the object side and a lens surface closest to an image side is a concave surface facing the image side. In the lens group M, adjacent lenses are cemented; or, they are separated by an air layer, in which the following conditional expressions are satisfied. Here, R1 denotes a curvature radius of a lens surface on the object side of the air layer, R2 denotes a curvature radius of a lens surface on the image side of the air layer, d denotes a thickness of the air layer on an optical axis, t1 denotes a thickness of a lens component on the optical axis on the object side of the air layer, and t2 denotes a thickness of a lens component on the optical axis on the image side of the air layer.

0≤|1/R1−1/R2|×(t1+t2)≤0.8

0≤d/(t1+t2)≤0.2

### BRIEF DESCRIPTION OF THE DRAWINGS

FIG. 1 is a cross-sectional view of an objective according to Example 1 of the present invention;

FIG. 2 is a cross-sectional view of an imaging lens;

FIG. 3A is a spherical aberration diagram of an optical system including the objective and the imaging lens in a first state;

FIG. 3B is a diagram illustrating an amount of sine condition violation of the optical system including the objective and the imaging lens in the first state;

FIG. 3C is an astigmatism diagram of the optical system including the objective and the imaging lens in the first state;

FIG. 3D is a coma aberration diagram of the optical system including the objective and the imaging lens in the first state;

FIG. 4A is a spherical aberration diagram of the optical system including the objective and the imaging lens in a second state;

FIG. 4B is a diagram illustrating an amount of sine condition violation of the optical system including the objective and the imaging lens in the second state;

FIG. 4C is an astigmatism diagram of the optical system including the objective and the imaging lens in the second state;

FIG. 4D is a coma aberration diagram of the optical system including the objective and the imaging lens in the second state;

FIG. 5A is a spherical aberration diagram of the optical system including the objective and the imaging lens in a third state;

FIG. 5B is a diagram illustrating an amount of sine condition violation of the optical system including the objective and the imaging lens in the third state;

FIG. 5C is an astigmatism diagram of the optical system including the objective and the imaging lens in the third state;

FIG. 5D is a coma aberration diagram of the optical system including the objective and the imaging lens in the third state;

FIG. 6 is a cross-sectional view of an objective according to Example 2 of the present invention;

FIG. 7A is a spherical aberration diagram of an optical system including the objective and the imaging lens in a first state;

FIG. 7B is a diagram illustrating an amount of sine condition violation of the optical system including the objective and the imaging lens in the first state;

FIG. 7C is an astigmatism diagram of the optical system including the objective and the imaging lens in the first state;

FIG. 7D is a coma aberration diagram of the optical system including the objective and the imaging lens in the first state;

FIG. 8A is a spherical aberration diagram of the optical system including the objective and the imaging lens in a second state;

FIG. 8B is a diagram illustrating an amount of sine condition violation of the optical system including the objective and the imaging lens in the second state;

FIG. 8C is an astigmatism diagram of the optical system including the objective and the imaging lens in the second state;

FIG. 8D is a coma aberration diagram of the optical system including the objective and the imaging lens in the second state;

FIG. 9A is a spherical aberration diagram of the optical system including the objective and the imaging lens in a third state;

FIG. 9B is a diagram illustrating an amount of sine condition violation of the optical system including the objective and the imaging lens in the third state;

FIG. 9C is an astigmatism diagram of the optical system including the objective and the imaging lens in the third state;

FIG. 9D is a coma aberration diagram of the optical system including the objective and the imaging lens in the third state;

FIG. 10 is a cross-sectional view of an objective according to Example 3 of the present invention;

FIG. 11A is a spherical aberration diagram of an optical system including the objective and the imaging lens in a first state;

FIG. 11B is a diagram illustrating an amount of sine condition violation of the optical system including the objective and the imaging lens in the first state;

FIG. 11C is an astigmatism diagram of the optical system including the objective and the imaging lens in the first state;

FIG. 11D is a coma aberration diagram of the optical system including the objective and the imaging lens in the first state;

FIG. 12A is a spherical aberration diagram of the optical system including the objective and the imaging lens in a second state;

FIG. 12B is a diagram illustrating an amount of sine condition violation of the optical system including the objective and the imaging lens in the second state;

FIG. 12C is an astigmatism diagram of the optical system including the objective and the imaging lens in the second state;

FIG. 12D is a coma aberration diagram of the optical system including the objective and the imaging lens in the second state;

FIG. 13A is a spherical aberration diagram of the optical system including the objective and the imaging lens in a third state;

FIG. 13B is a diagram illustrating an amount of sine condition violation of the optical system including the objective and the imaging lens in the third state;

FIG. 13C is an astigmatism diagram of the optical system including the objective and the imaging lens in the third state;

FIG. 13D is a coma aberration diagram of the optical system including the objective and the imaging lens in the third state;

FIG. 14 is a cross-sectional view of an objective according to Example 4 of the present invention;

FIG. 15A is a spherical aberration diagram of an optical system including the objective and the imaging lens in a first state;

FIG. 15B is a diagram illustrating an amount of sine condition violation of the optical system including the objective and the imaging lens in the first state;

FIG. 15C is an astigmatism diagram of the optical system including the objective and the imaging lens in the first state;

FIG. 15D is a coma aberration diagram of the optical system including the objective and the imaging lens in the first state;

FIG. 16A is a spherical aberration diagram of the optical system including the objective and the imaging lens in a second state;

FIG. 16B is a diagram illustrating an amount of sine condition violation of the optical system including the objective and the imaging lens in the second state;

FIG. 16C is an astigmatism diagram of the optical system including the objective and the imaging lens in the second state;

FIG. 16D is a coma aberration diagram of the optical system including the objective and the imaging lens in the second state;

FIG. 17A is a spherical aberration diagram of the optical system including the objective and the imaging lens in a third state;

FIG. 17B is a diagram illustrating an amount of sine condition violation of the optical system including the objective and the imaging lens in the third state;

FIG. 17C is an astigmatism diagram of the optical system including the objective and the imaging lens in the third state;

FIG. 17D is a coma aberration diagram of the optical system including the objective and the imaging lens in the third state;

FIG. 18 is a cross-sectional view of an objective according to Example 5 of the present invention;

FIG. 19A is a spherical aberration diagram of an optical system including the objective and the imaging lens in a first state;

FIG. 19B is a diagram illustrating an amount of sine condition violation of the optical system including the objective and the imaging lens in the first state;

FIG. 19C is an astigmatism diagram of the optical system including the objective and the imaging lens in the first state;

FIG. 19D is a coma aberration diagram of the optical system including the objective and the imaging lens in the first state;

FIG. 20A is a spherical aberration diagram of the optical system including the objective and the imaging lens in a second state;

FIG. 20B is a diagram illustrating an amount of sine condition violation of the optical system including the objective and the imaging lens in the second state;

FIG. 20C is an astigmatism diagram of the optical system including the objective and the imaging lens in the second state;

FIG. 20D is a coma aberration diagram of the optical system including the objective and the imaging lens in the second state;

FIG. 21A is a spherical aberration diagram of the optical system including the objective and the imaging lens in a third state;

FIG. 21B is a diagram illustrating an amount of sine condition violation of the optical system including the objective and the imaging lens in the third state;

FIG. 21C is an astigmatism diagram of the optical system including the objective and the imaging lens in the third state;

FIG. 21D is a coma aberration diagram of the optical system including the objective and the imaging lens in the third state;

FIG. 22 is a cross-sectional view of an objective according to Example 6 of the present invention;

FIG. 23A is a spherical aberration diagram of an optical system including the objective and the imaging lens in a first state;

FIG. 23B is a diagram illustrating an amount of sine condition violation of the optical system including the objective and the imaging lens in the first state;

FIG. 23C is an astigmatism diagram of the optical system including the objective and the imaging lens in the first state;

FIG. 23D is a coma aberration diagram of the optical system including the objective and the imaging lens in the first state;

FIG. 24A is a spherical aberration diagram of the optical system including the objective and the imaging lens in a second state;

FIG. 24B is a diagram illustrating an amount of sine condition violation of the optical system including the objective and the imaging lens in the second state;

FIG. 24C is an astigmatism diagram of the optical system including the objective and the imaging lens in the second state;

FIG. 24D is a coma aberration diagram of the optical system including the objective and the imaging lens in the second state;

FIG. 25A is a spherical aberration diagram of the optical system including the objective and the imaging lens in a third state;

FIG. 25B is a diagram illustrating an amount of sine condition violation of the optical system including the objective and the imaging lens in the third state;

FIG. 25C is an astigmatism diagram of the optical system including the objective and the imaging lens in the third state;

FIG. 25D is a coma aberration diagram of the optical system including the objective and the imaging lens in the third state;

FIG. 26 is a cross-sectional view of an objective according to Example 7 of the present invention;

FIG. 27A is a spherical aberration diagram of an optical system including the objective and the imaging lens in a first state;

FIG. 27B is a diagram illustrating an amount of sine condition violation of the optical system including the objective and the imaging lens in the first state;

FIG. 27C is an astigmatism diagram of the optical system including the objective and the imaging lens in the first state;

FIG. 27D is a coma aberration diagram of the optical system including the objective and the imaging lens in the first state;

FIG. 28A is a spherical aberration diagram of the optical system including the objective and the imaging lens in a second state;

FIG. 28B is a diagram illustrating an amount of sine condition violation of the optical system including the objective and the imaging lens in the second state;

FIG. 28C is an astigmatism diagram of the optical system including the objective and the imaging lens in the second state;

FIG. 28D is a coma aberration diagram of the optical system including the objective and the imaging lens in the second state;

FIG. 29A is a spherical aberration diagram of the optical system including the objective and the imaging lens in a third state;

FIG. 29B is a diagram illustrating an amount of sine condition violation of the optical system including the objective and the imaging lens in the third state;

FIG. 29C is an astigmatism diagram of the optical system including the objective and the imaging lens in the third state; and

FIG. 29D is a coma aberration diagram of the optical system including the objective and the imaging lens in the third state.

### DETAILED DESCRIPTION

The objectives in the related art have large off-axis aberrations including field curvature aberrations, and it is difficult to achieve high performance in a wide field of view. In view of such circumstances described above, an object of an aspect of the present invention is to provide an objective having high NA and a long WD in which off-axis performance with respect to specimens and immersion liquids having various refractive indices is favorably corrected.

An objective according to an embodiment of the present application will be described. The objective according to the present embodiment (hereinafter simply described as an objective) is an infinity-corrected microscope objective used in combination with an imaging lens and is an immersion microscope objective used in a state in which a space to an object that is an observation target is filled with an immersion liquid. In the present specification, a lens component refers to a single lens block in which only two surfaces that are a surface on an object side and a surface on an image side among lens surfaces through which a light ray from an object point passes are brought into contact with air regardless of whether the lens is a single lens or a cemented lens. In other words, one single lens is one lens component, and one cemented lens is also one lens component. On the other hand, a plurality of single lenses and a plurality of cemented lenses arranged with air therebetween are not referred to as one lens component herein. In addition, a meniscus lens component refers to a lens component having a meniscus lens shape, and refers to a lens component in which one of a surface closest to the object side and a surface closest to the image side of the lens component is a concave surface and the other is a convex surface.

The objective includes a first lens group having positive refractive power, a second lens group having positive refractive power, a third lens group, and a fourth lens group which are arranged in order from the object side. The second lens group is a moving group that is moved along an optical axis. The third lens group and the fourth lens group are arranged so that concave surfaces adjacent to each other face each other. In a case where there are a plurality of sets of concave surfaces facing each other on the image side of the moving group, the set closest to the image side among the sets is a boundary between the third lens group and the fourth lens group. The third lens group includes a lens group M including two or more positive lenses and two or more negative lenses. The third lens group may further include a lens component other than the lens group M. The lens group M has a substantially integrated configuration, a lens surface of the lens group M which is closest to the object side is a convex surface facing the object side, and a lens surface of the lens group M which is closest to the image side is a concave surface facing the image side. Note that details of the substantially integrated configuration will be described below.

In the objective configured as described above, the divergence of light from the object point is sufficiently reduced by the first lens group having the positive refractive power and then is incident on the second lens group that is the moving group. A marginal light ray height passing through the second lens group located closer to the object side with respect to the third lens group to be described below is relatively high. Therefore, by the movement of the second lens group, it is possible to significantly change the amount of occurrence of spherical aberration by significantly changing the marginal light ray height when the light passes through the second lens group, and the spherical aberration due to a difference in refractive index of the immersion liquid can be effectively corrected.

In addition, in the objective, the light having passed through the second lens group is converted into parallel light while various aberrations are favorably corrected by the third lens group and the fourth lens group. The third lens group and the fourth lens group include a so-called Gaussian group. Here, the Gaussian group is an optical system that has a pair of concave surfaces facing each other on an inner side and has convex surfaces at both ends (on outer sides). The third lens group and the fourth lens group include the Gaussian group in which the surface of the third lens group which is closest to the image side and the surface of the fourth lens group which is closest to the object side face each other are concave surfaces facing each other, thereby enabling the marginal light ray height to be reduced in the concave surfaces facing each other. Therefore, the Petzval sum can be effectively corrected, and a field curvature can be sufficiently reduced.

In addition, in the objective, the third lens group includes the lens group M. The lens group M having a substantially integrated configuration can be regarded as an object side portion (a meniscus lens group) of a Gaussian group, the object side portion having a meniscus shape that is convex on a side closest to the object side and is concave on the other side closest to the image side as a whole. Since a large thickness of the lens group M can generate a large difference between a marginal light ray height on a convex surface of the lens group M which is closest to the object side and a marginal light ray height on a concave surface thereof closest to the image side, the Petzval sum can be more effectively corrected, and off-axis performance can be favorably corrected. In addition, the lens group M includes two or more positive lenses and two or more negative lenses, thereby enabling a pair of a positive lens and a negative lens having an achromatic effect to be formed in a region on the object side where the marginal light ray height is high in the lens group M. Therefore, it is possible to favorably correct an axial chromatic aberration.

Note that a configuration in which the lens groups are substantially integrated means that adjacent lenses are cemented, or the following conditional expressions are satisfied in a case where the adjacent lenses are separated by an air layer. Note that, in a case where a plurality of air layers are present in the lens group, the following conditional expressions are satisfied for each air layer. In other words, the substantially integrated configuration may be one lens component in which all lenses are cemented, or may be two or more lens components as long as an air layer between the lens components is sufficiently thin to the extent that the air layer is defined by the following conditional expression.

0≤|1/R1−1/R2|×(t1+t2)≤0.8 (1)

0≤d/(t1+t2)≤0.2 (2)

Here, R1 denotes a curvature radius of a lens surface on the object side of the air layer. Here, the lens surface on the object side of the air layer is a lens surface on the object side which is in contact with the air layer. R2 denotes a curvature radius of a lens surface on the image side of the air layer. Here, the lens surface on the image side of the air layer is a lens surface on the image side which is in contact with the air layer, d denotes a spacing between lens surfaces of the air layer on the optical axis, and t1 denotes a thickness of a lens component on the optical axis on the object side of the air layer. Here, the lens component on the object side of the air layer is a lens component on the object side which is in contact with the air layer, and t2 denotes a thickness of the lens component on the optical axis on the image side of the air layer. Here, the lens component on the image side of the air layer is a lens component on the image side which is in contact with the air layer.

Conditional Expression (1) defines that a difference in curvature between lens surfaces adjacent to each other with the air layer interposed therebetween is sufficiently small, and Conditional Expression (2) defines that a thickness of the air layer on the optical axis is sufficiently small. In other words, these two conditional expressions define that the thickness of the air layer is small on the optical axis and small even when being apart from the optical axis. If |1/R1−1/R2|×(t1+t2) is larger than an upper limit value, or d/(t1+t2) is larger than an upper limit value, a difference in light ray height on both sides of the air layer increases too much. Therefore, it is difficult to sufficiently reduce the marginal light ray height on the concave surface of the lens group M which is closest to the image side without reducing a curvature radius of the convex surface that is in contact with the air layer, and it is difficult to effectively correct the Petzval sum.

According to the objective configured as described above, the off-axis performance with respect to specimens or immersion liquids having various refractive indices can be favorably corrected while a long working distance and a high NA are achieved. A desirable configuration of the objective will be described below.

It is desirable that the objective be configured to satisfy Conditional Expression (3) below.

0.15≤Φ_{L}/TL≤0.8 (3)

Here, Φ_{L} denotes a lens outer diameter of a lens of the objective which is closest to the image side. In addition, TL denotes a distance on the optical axis from a lens surface of the objective which is closest to the object side to a lens surface of the objective which is closest to the image side. Note that an outer diameter of a lens is usually a value that is, by about 0.5 mm to 1 mm, larger than an effective diameter (diameter) of a surface of the lens on the image side.

Conditional Expression (3) is a conditional expression for reducing the vignetting over a wide field of view and correcting the field curvature favorably. In the objective having a long focal length and a low magnification for realizing a wide field of view, a diameter of an optical surface of the lens closest to the image side can be prevented from becoming too small by preventing Φ_{L}/TL from becoming smaller than the lower limit value. Consequently, a distance between a final surface and an exit pupil position can be maintained long while an exit area is maintained large by reducing the vignetting of an off-axis light ray. Therefore, an effect of correcting the Petzval sum of the Gaussian group included in the third lens group and the fourth lens group can be more significantly exhibited, and the field curvature can be effectively corrected. In addition, Φ_{L}/TL is not larger than the upper limit value, thereby enabling stiffness of the lens to be secured and enabling an increase in size of the objective to be avoided.

Note that the objective may be configured to satisfy Conditional Expression (1-1) or Conditional Expression (1-2) below, in addition to Conditional Expression (1). In addition, the objective may be configured to satisfy Conditional Expression (2-1) or Conditional Expression (2-2) below, in addition to Conditional Expression (2). In addition, the objective may be configured to satisfy Conditional Expression (3-1) or Conditional Expression (3-2) below, in addition to Conditional Expression (3).

0≤|1/R1−1/R2|×(t1+t2)≤0.6 (1-1)

0≤|1/R1−1/R2|×(t1+t2) ≤0.4 (1-2)

0≤d/(t1+t2)≤0.1 (2-1)

0≤dk/(t1+t2)≤0.05 (2-2)

0.20≤Φ_{L}/TL≤0.7 (3-1)

0.23≤Φ_{L}/TL≤0.6 (3-2)

It is desirable that the first lens group include a first lens component located closest to the object side, and a meniscus lens. The first lens group includes the first lens component and the meniscus lens, thereby enabling a high numerical aperture to be ensured by the first lens component and subsequently enabling divergence of light rays to be curbed by the meniscus lens following the first lens component. In addition, a higher-order aberration can be curbed from occurring by gradually bending the light rays. Further, it is desirable that the first lens component be a cemented lens component in which a positive lens having a convex surface facing the image side and a meniscus lens having a concave surface facing the object side are cemented. The first lens component positioned closest to the object side is the cemented lens including the positive lens having the convex surface facing the image side and the meniscus lens having the concave surface facing the object side, thereby enabling the field curvature to be favorably corrected. More specifically, by imparting a refraction action due to the concave surface of the meniscus lens at a cemented surface of the first lens component on which light emitted from the object point is incident before the marginal light ray height increases, it is possible to effectively correct the Petzval sum. In addition, since a lens cemented to the concave surface of the meniscus lens on the object side is a positive lens, a first surface (lens surface closest to the object side) of the objective does not become a strong concave surface. Hence, it is possible to avoid generation of air bubbles on an optical path when the objective is immersed in an immersion liquid, and as a result, it is possible to avoid generation of an aberration.

It is desirable that the second lens group be configured to convert divergent pencils of rays into convergent pencils of rays. When the divergent pencils of rays are converted into the convergent pencils of rays in the second lens group, an axial marginal light ray height reaches a maximum height in the second lens group. Therefore, it is possible to increase a change in spherical aberration due to the movement of the second lens group, and it is possible to correct the spherical aberration by changing the spherical aberration according to various immersion liquids. In addition, it is desirable that the second lens group be a three-lens cemented lens component including a biconvex lens, a biconcave lens, and a biconvex lens. The second lens group having the high axial marginal light ray height is configured as a three-lens cemented lens component having a large chromatic aberration correcting effect, thereby enabling the axial chromatic aberration to be changed and corrected by the movement of the second lens group.

It is desirable that the fourth lens group include two or more lens components, and it is desirable that each of the two or more lens components be a meniscus lens component having a concave surface facing the object side. Note that, of the two or more lens components, a lens component closest to the object side can be regarded as an image side portion (a meniscus lens group) of the Gauss group. It is preferable that, in the fourth lens group located closest to the image side, a lens pair having a different dispersion characteristic be arranged in order to correct a lateral chromatic aberration. However, when the lens pair having different dispersion characteristics is cemented, a large difference occurs in a coma aberration and astigmatism generated at a cemented surface due to a wavelength. On the contrary, the fourth lens group is configured to include two or more lens components, thereby enabling one or more pairs of air interfaces (that is, one or more gaps generated between the lens components) to be provided in addition to the concave surface that has the Petzval sum correcting action and faces the concave surface of the third lens group which is closest to the image side. Therefore, it is possible to favorably correct astigmatism and a coma aberration by making differences in refraction angle and light ray height of an off-axis light ray at these surfaces (the concave surface facing the third lens group and the one or more pairs of air interfaces). As a result, the lateral chromatic aberration, the astigmatism, and the coma aberration can be corrected more favorably in a wide wavelength range.

Hereinafter, examples of the above-described objective will be described in detail. The objective of each example is an immersion microscope objective and satisfies Conditional Expression below. Here, the NA is the numerical aperture of the objective on the object side, and the WD is the working distance of the objective. In addition, the magnification of the objective is 30 times or lower.

0.9≤NA×WD [mm] (4)

If NA×WD is smaller than the lower limit value, at least one of the numerical aperture and the working distance becomes too small. If the numerical aperture is small, sufficient resolution cannot be obtained, and brightness in fluorescence observation is also insufficient. In addition, if the working distance is too short, it is difficult to observe a deep portion of a specimen in a case where a culture vessel having a thick bottom surface is used, in a case where the specimen is thick, or the like. In addition, when the magnification is set to a high magnification of 30 times or higher, it becomes difficult to acquire an image at a time without tiling a three-dimensional structure representing a spheroid. The objective according to the following example satisfies Conditional Expression (4) and has a low magnification of 30 times or lower. Hence, it is possible to have sufficient resolution, observe a deep portion of a specimen, and acquire an image at a time without tiling the spheroid or the like.

### EXAMPLE 1

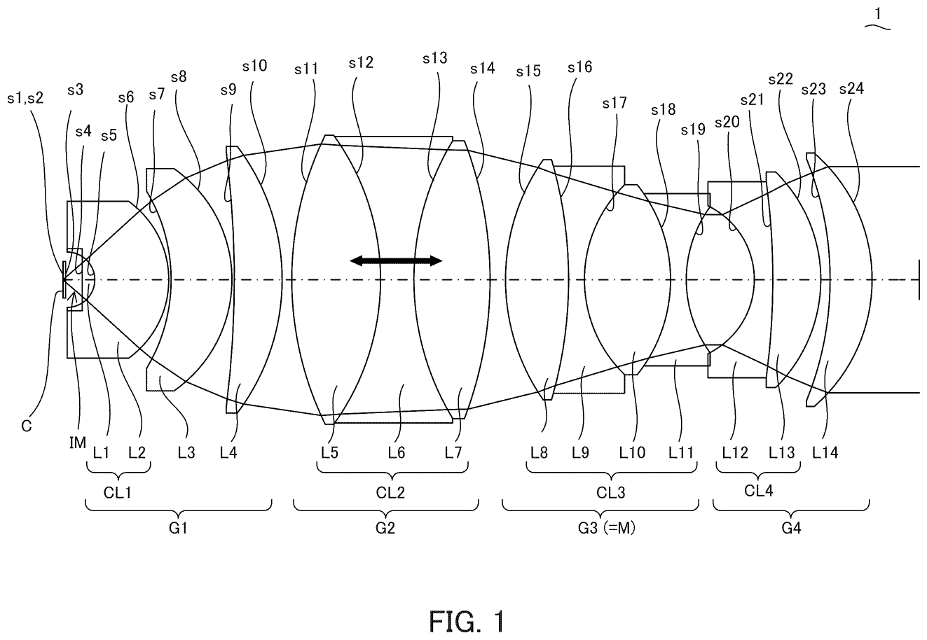

FIG. 1 is a cross-sectional view of an objective 1 according to the present example. The objective 1 is a liquid immersion objective for microscope. The objective 1 includes, in order from the object side, a first lens group G1 that has positive refractive power, a second lens group G2 that is moved along an optical axis and has positive refractive power, a third lens group G3, and a fourth lens group G4.

The first lens group G1 includes, in order from the object side, a cemented lens CL1, a lens L3 that is a meniscus lens having a concave surface facing the object side, and a lens L4 that is a meniscus lens having a concave surface facing the object side. The cemented lens CL1 is a two-lens cemented lens in which a lens L1 that is a positive lens having a flat surface facing the object side, that is, a positive lens having a convex surface facing the image side, and a lens L2 that is a meniscus lens having a concave surface facing the object side are cemented, and the cemented lens CL1 is a first lens component having positive refractive power.

The second lens group G2 includes a cemented lens CL2 that is moved along the optical axis. The cemented lens CL2 is a three-lens cemented lens in which a lens L5 that is a biconvex lens, a lens L6 that is a biconcave lens, and a lens L7 that is a biconvex lens are cemented.

The third lens group G3 includes a cemented lens CL3. The cemented lens CL3 is a four-lens cemented lens in which a lens L8 that is a biconvex lens, a lens L9 that is a biconcave lens, a lens L10 that is a biconvex lens, and a lens L11 that is a biconcave lens are cemented. The cemented lens CL3 is the lens group M which has a convex surface closest to the object side and a concave surface closest to the image side and includes two positive lenses and two negative lenses, and in which adjacent lenses are cemented.

The fourth lens group G4 includes, in order from the object side, a cemented lens CL4 and a lens L14 that is a meniscus lens having a concave surface facing the object side. The cemented lens CL4 is a two-lens cemented lens in which a lens L12 that is a meniscus lens having a concave surface facing the object side and a lens L13 that is a meniscus lens having a concave surface facing the object side are cemented.

Various items of data of the objective 1 are as follows. Note that f, f_{G1}, f_{G2}, f_{G3}, and f_{G4} are a focal length of the objective 1, a focal length of the first lens group G1, a focal length of the second lens group G2, a focal length of the third lens group G3, and a focal length of the fourth lens group G4, respectively. Note that a reference wavelength is the d-line.

NA=1.0, f=7.205 mm, f_{G1}=9.962 mm, f_{G2}=26.134 mm, f_{G3}=−23.107 mm, f_{G4}=301.639 mm, Φ_{L}=15.80 mm, TL=50.182 mm

Lens data of the objective 1 is as follows. Note that the INF in the lens data indicates infinity (∞).

### Objective Lens 1

s r d nd νd
1 INF 0 nᵢₘ νᵢₘ
2 INF 0.17 1.52397 54.41
3 INF D3 nᵢₘ νᵢₘ
4 INF 0.800 1.51633 64.14
5 −1.7620 4.700 1.88300 40.76
6 −6.1650 0.150
7 −10.9660 3.864 1.75500 52.32
8 −8.6411 0.152
9 −64.4128 3.034 1.49700 81.54
10 −14.0520 D10
11 20.9945 5.641 1.56907 71.30
12 −15.7068 2.117 1.63775 42.41
13 17.0699 4.841 1.56907 71.30
14 −24.8211 D14
15 13.3958 4.012 1.49700 81.54
16 −27.4601 1.001 1.63775 42.41
17 8.4340 5.472 1.56907 71.30
18 −9.6944 1.000 1.63775 42.41
19 7.9031 4.324
20 −5.2336 1.171 1.73800 32.33
21 −47.3844 3.051 1.49700 81.54
22 −9.6498 0.592
23 −20.4673 2.667 1.85478 24.80
24 −10.6831 110.000

Here, s denotes a surface number, r denotes a curvature radius (mm), d denotes a surface spacing (mm), nd denotes a refractive index, and νd denotes an Abbe number. Note that the reference wavelength is the d-line (587.56 nm). These symbols are similarly used in the following examples. A surface indicated by a surface numbers s1 is an object surface. Surfaces indicated by surface numbers s2 and s3 are a surface of a cover glass C on the object side and a surface of the cover glass C on the image side. Surfaces indicated by surface numbers s4 and s24 are a lens surface of the objective 1 which is closest to the object side and a lens surface of the objective 1 which is closest to the image side, respectively. A space between the cover glass C and the lens surface of the objective 1 which is closest to the object side is filled with an immersion liquid IM. The refractive index and the Abbe number of the immersion liquid IM are denoted by nᵢₘ and νᵢₘ, respectively. In addition, for example, a surface spacing d1 indicates a distance on the optical axis from the surface indicated by the surface number s1 to the surface indicated by the surface number s2. Note that a surface spacing d24 indicates a distance on the optical axis from the surface indicated by the surface number s24 to an imaging lens and is 110 mm.

In the observation performed by using the objective 1, the immersion liquid IM to be used is changed depending on the refractive index of the object, and the second lens group G2 is moved so that the aberrations are corrected. A first state, a second state, and a third state to be described below are states in which the second lens group G2 has been moved depending on respective different immersion liquids. In each state, the refractive index nᵢₘ and the Abbe number νᵢₘ of the immersion liquid, and D3, D10, and D14 that are values (unit: mm) of spacings d3, d10, and d14 in the lens data are as follows.
First state Second state Third state
nᵢₘ1.51495 1.40000 1.56000
νᵢₘ41.0 45.5 39.5
D3 1.049 0.979 1.079
D10 0.611 1.378 0.350
D14 0.981 0.214 1.242

The objective 1 satisfies Conditional Expressions (3) and (4) as will be described below. Since the lens group M of the third lens group G3 is a single lens component, the lens group M does not have the configuration that needs to satisfy Conditional Expressions (1) and (2).

Φ_{L}/TL=0.31 (3)

NA×WD=0.98 mm (4)
(*) The minimum value of WD is 0.979 mm in the second state.

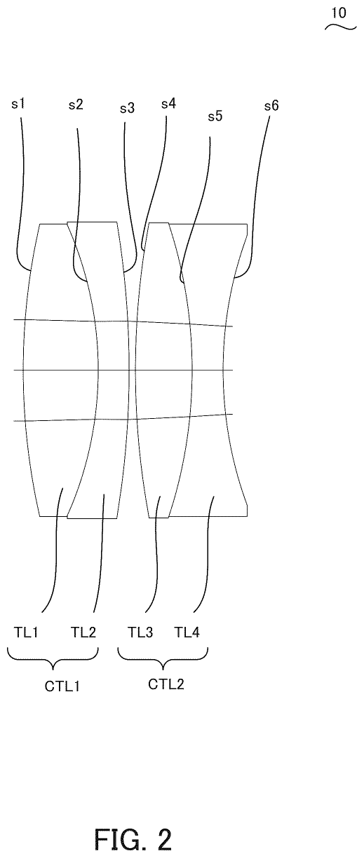

FIG. 2 is a cross-sectional view of an imaging lens 10 used in combination with the objective 1. The imaging lens 10 is a microscope imaging lens that forms an enlarged image of an object in combination with an infinity-corrected objective. The imaging lens 10 includes a cemented lens CTL1 and a cemented lens CTL2 which are arranged in order from the object side. The cemented lens CTL1 is a two-lens cemented lens including a lens TL1 that is a biconvex lens and a lens TL2 that is a meniscus lens having a concave surface facing the object side. The cemented lens CTL2 is a two-lens cemented lens including a lens TL3 that is a biconvex lens and a lens TL4 that is a biconcave lens. Note that a focal length ft of the imaging lens 10 is 180 mm.

Lens data of the imaging lens 10 is as follows.

### Imaging Lens 10

s r d nd νd
1 68.7541 7.7321 1.48749 70.21
2 −37.5679 3.4742 1.80610 40.95
3 −102.8477 0.6973
4 84.3099 6.024 1.83400 37.17
5 −50.7100 3.030 1.64450 40.82
6 40.6619 9.038

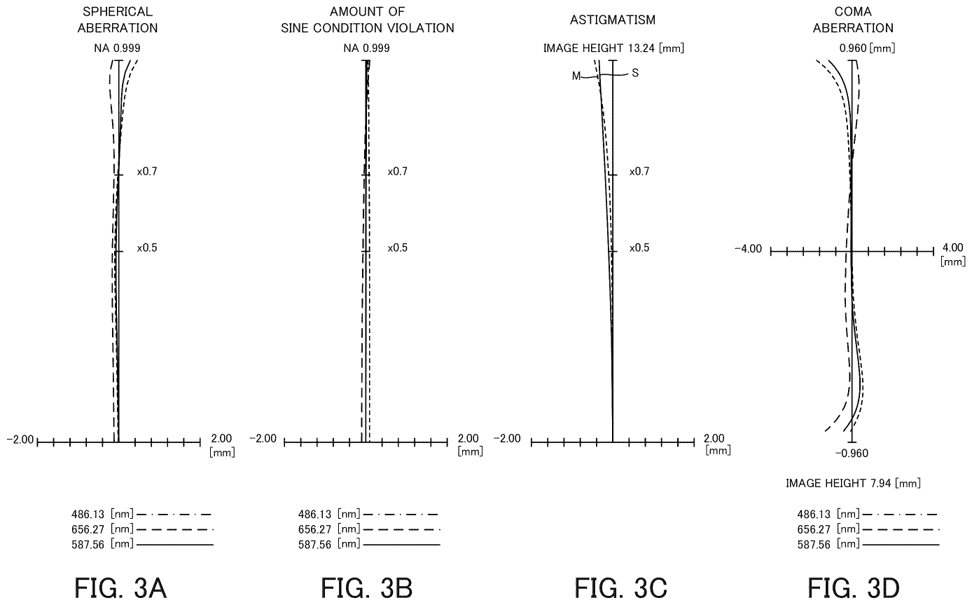

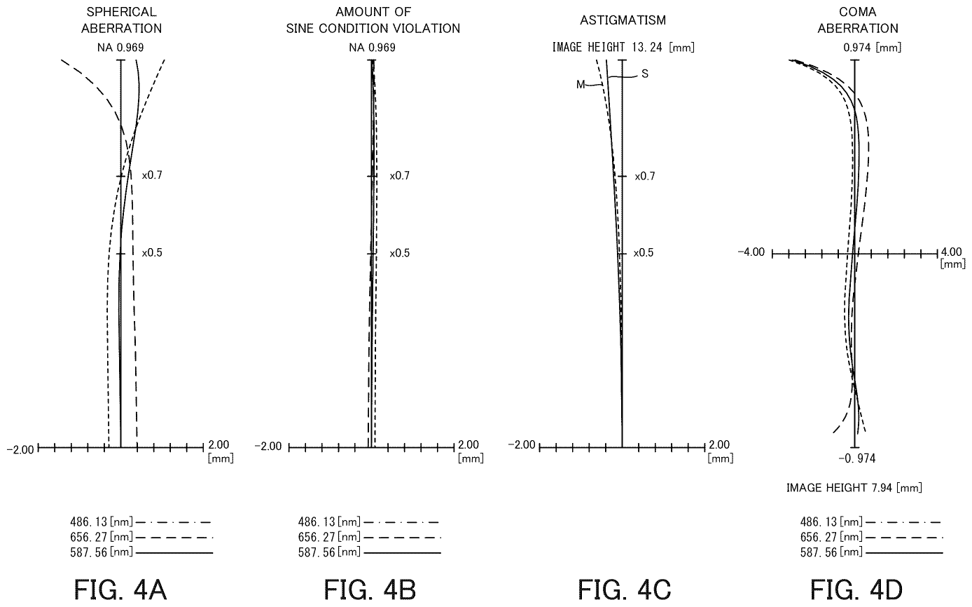

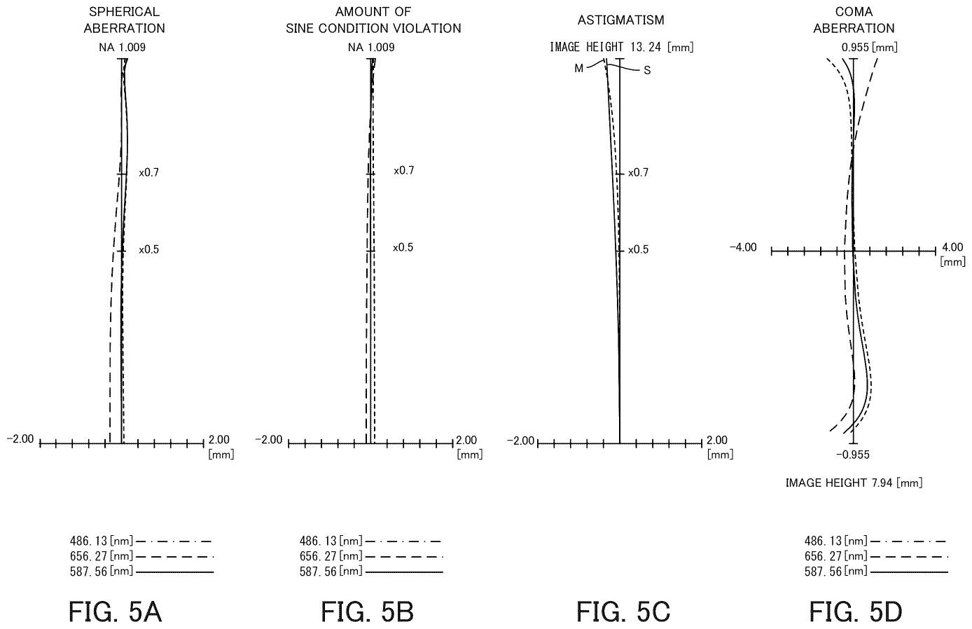

FIGS. 3A to 5D are aberration diagrams of an optical system including the objective 1 and the imaging lens 10 and illustrate aberrations at an image plane formed by the objective 1 and the imaging lens 10 in the first state, the second state, and the third state, respectively. FIGS. 3A, 4A, and 5A are spherical aberration diagrams. FIGS. 3B, 4B, and 5B are diagrams illustrating the amounts of sine condition violation. FIGS. 3C, 4C, and 5C are astigmatism diagrams. FIGS. 3D, 4D, and 5D are coma aberration diagrams at an image height ratio of 0.6 (an image height of 7.94 mm). Note that, in the figures, “M” denotes a meridional component, and “S” denotes a sagittal component. As illustrated in FIGS. 3A to 5D, in the present example, the aberrations are favorably corrected regardless of the immersion liquids in the case of using the immersion liquids depending on a refractive index of an object.

### EXAMPLE 2

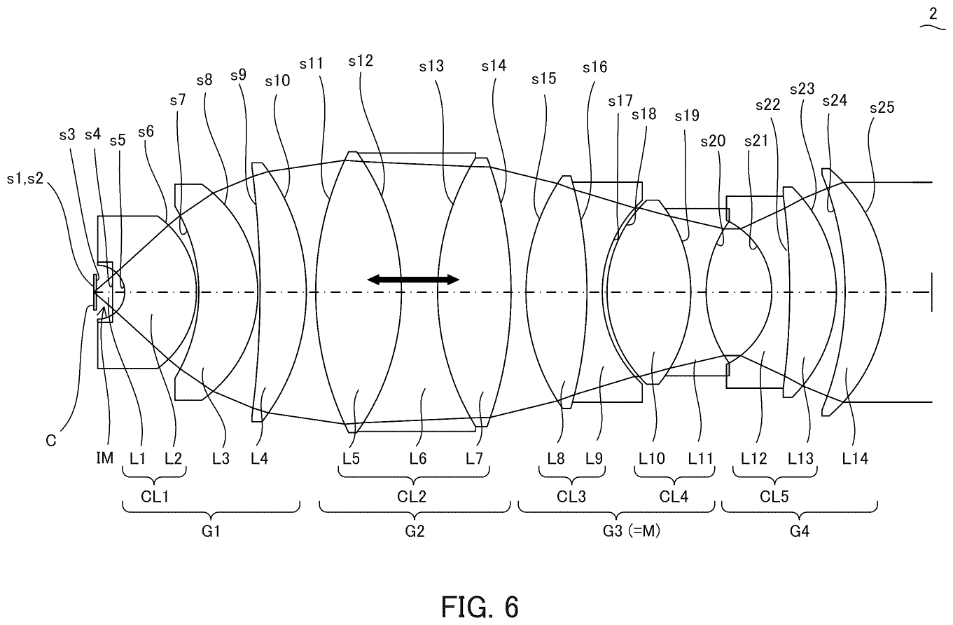

FIG. 6 is a cross-sectional view of an objective 2 according to the present example. The objective 2 is a liquid immersion objective for microscope. The objective 2 includes, in order from the object side, a first lens group G1 that has positive refractive power, a second lens group G2 that is moved along an optical axis and has positive refractive power, a third lens group G3, and a fourth lens group G4.

The first lens group G1 includes, in order from the object side, a cemented lens CL1, a lens L3 that is a meniscus lens having a concave surface facing the object side, and a lens L4 that is a meniscus lens having a concave surface facing the object side. The cemented lens CL1 is a two-lens cemented lens in which a lens L1 that is a positive lens having a flat surface facing the object side, that is, a positive lens having a convex surface facing the image side, and a lens L2 that is a meniscus lens having a concave surface facing the object side are cemented, and the cemented lens CL1 is a first lens component having positive refractive power.

The second lens group G2 includes a cemented lens CL2 that is moved along the optical axis. The cemented lens CL2 is a three-lens cemented lens in which a lens L5 that is a biconvex lens, a lens L6 that is a biconcave lens, and a lens L7 that is a biconvex lens are cemented.

The third lens group G3 includes, in order from the object side, a cemented lens CL3 and a cemented lens CL4. The cemented lens CL3 is a two-lens cemented lens in which a lens L8 that is a biconvex lens and a lens L9 that is a biconcave lens are cemented. The cemented lens CL4 is a two-lens cemented lens in which a lens L10 that is a biconvex lens and a lens L11 that is a biconcave lens are cemented. A lens group including the cemented lens CL3 and the cemented lens CL4 is the lens group M which has a convex surface closest to the object side and a concave surface closest to the image side and includes two positive lenses and two negative lenses and in which adjacent lenses satisfy Conditional Expressions (1) and (2) as will be described below.

The fourth lens group G4 includes, in order from the object side, a cemented lens CL5 and a lens L14 that is a meniscus lens having a concave surface facing the object side. The cemented lens CL5 is a two-lens cemented lens structured by cementing a lens L12 that is a meniscus lens having a concave surface facing the object side and a lens L13 that is a meniscus lens having a concave surface facing the object side.

Various items of data of the objective 2 are as follows.

NA=1.0, f=7.205 mm, f_{G1}=9.956 mm, f_{G2}=26.255 mm, f_{G3}=−22.982 mm, f_{G4}=281.004 mm, R1=8.21849 mm, R2=8.28566 mm, d=0.310 mm, t1=4.994 mm, t2=6.491 mm, Φ_{L}=16.00 mm, TL=50.629 mm

Lens data of the objective 2 is as follows.

### Objective Lens 2

s r d nd νd
1 INF 0 nᵢₘ νᵢₘ
2 INF 0.17 1.52397 54.41
3 INF D3 nᵢₘ νᵢₘ
4 INF 0.800 1.51633 64.14
5 −1.7620 4.700 1.88300 40.76
6 −6.1650 0.150
7 −10.9415 3.862 1.75500 52.32
8 −8.6517 0.150
9 −62.6055 3.026 1.49700 81.54
10 −13.8735 D10
11 20.6744 5.612 1.56907 71.30
12 −15.8841 2.365 1.63775 42.41
13 16.7725 4.808 1.56907 71.30
14 −25.4603 D14
15 13.2937 3.994 1.49700 81.54
16 −27.8407 1.000 1.63775 42.41
17 8.2185 0.310
18 8.2857 5.491 1.56907 71.30
19 −9.6959 1.000 1.63775 42.41
20 7.9130 4.297
21 −5.2435 1.173 1.73800 32.33
22 −46.5091 3.054 1.49700 81.54
23 −9.6302 0.573
24 −20.3904 2.674 1.85478 24.80
25 −10.6780 110.000

In the observation performed by using the objective 2, the immersion liquid IM to be used is changed depending on the refractive index of the object, and the second lens group G2 is moved so that the aberrations are corrected. A first state, a second state, and a third state to be described below are states in which the second lens group G2 has been moved depending on respective different immersion liquids. In each state, the refractive index nᵢₘ and the Abbe number νᵢₘ of the immersion liquid, and D3, D10, and D14 that are values (unit: mm) of spacings d3, d10, and d14 in the lens data are as follows.
First state Second state Third state
nᵢₘ 1.51495 1.40000 1.56000
νᵢₘ 41.0 45.5 39.5
d0 1.051 0.979 1.079
D_1 0.615 1.389 0.350
D_2 0.975 0.200 1.239

The objective 2 satisfies Conditional Expressions (1) to (4) as will be described below.

|1/R1−1/R2|×(t1+t2)=0.01 (1)

d/(t1+t2)=0.03 (2)

Φ_{L}/TL=0.32 (3)

NA×WD=0.98 mm (4)
(*) The minimum value of WD is 0.979 mm in the second state.

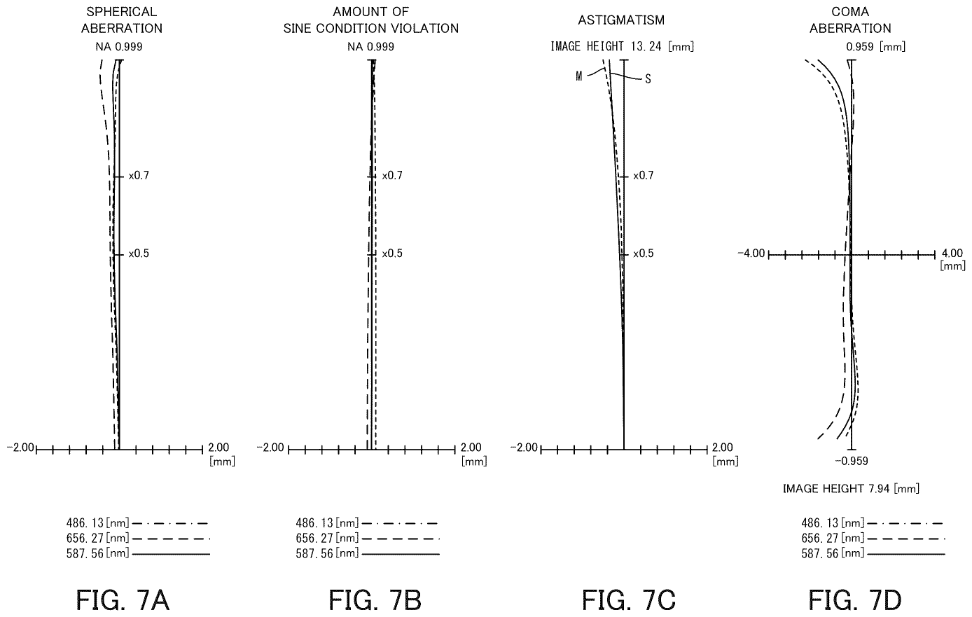

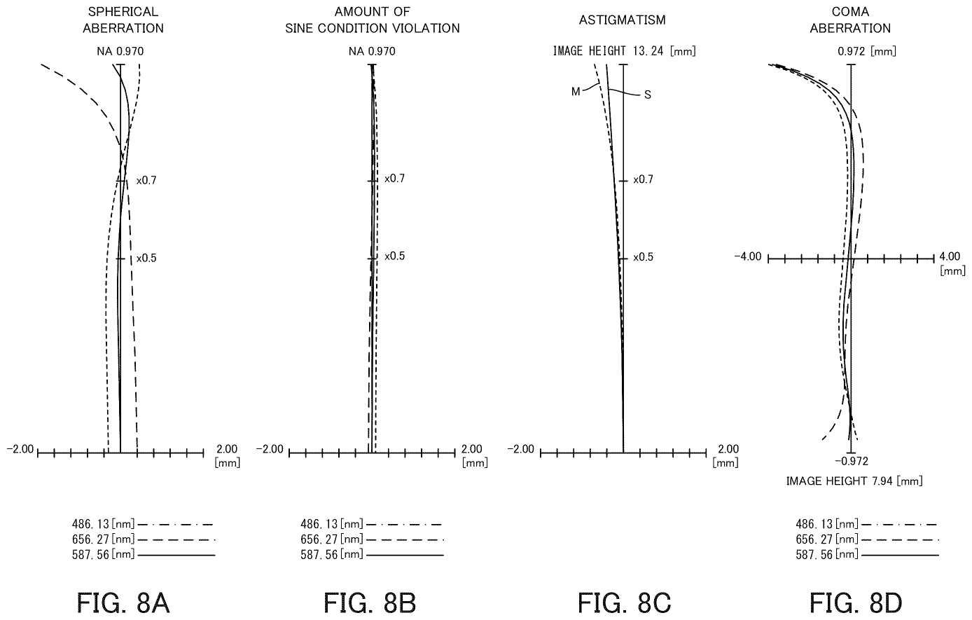

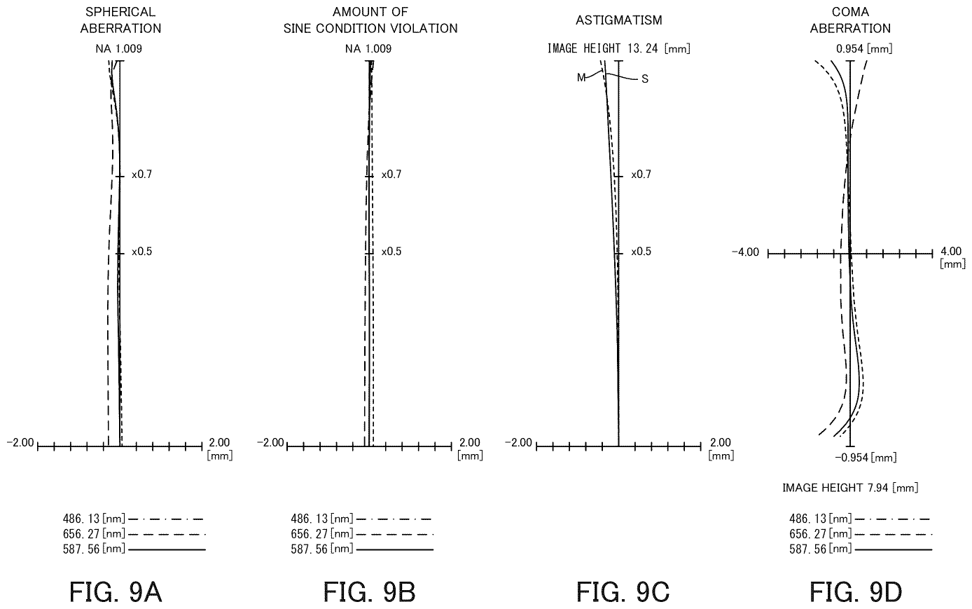

FIGS. 7A to 9D are aberration diagrams of an optical system including the objective 2 and the imaging lens 10 and illustrate aberrations at an image plane formed by the objective 2 and the imaging lens 10 in the first state, the second state, and the third state, respectively. FIGS. 7A, 8A, and 9A are spherical aberration diagrams. FIGS. 7B, 8B, and 9B are diagrams illustrating the amounts of sine condition violation. FIGS. 7C, 8C, and 9C are astigmatism diagrams. FIGS. 7D, 8D, and 9D are coma aberration diagrams at the image height ratio of 0.6 (the image height of 7.94 mm). As illustrated in FIGS. 7A to 9D, in the present example, the aberrations are favorably corrected regardless of the immersion liquids in the case of using the immersion liquids depending on a refractive index of an object.

### EXAMPLE 3

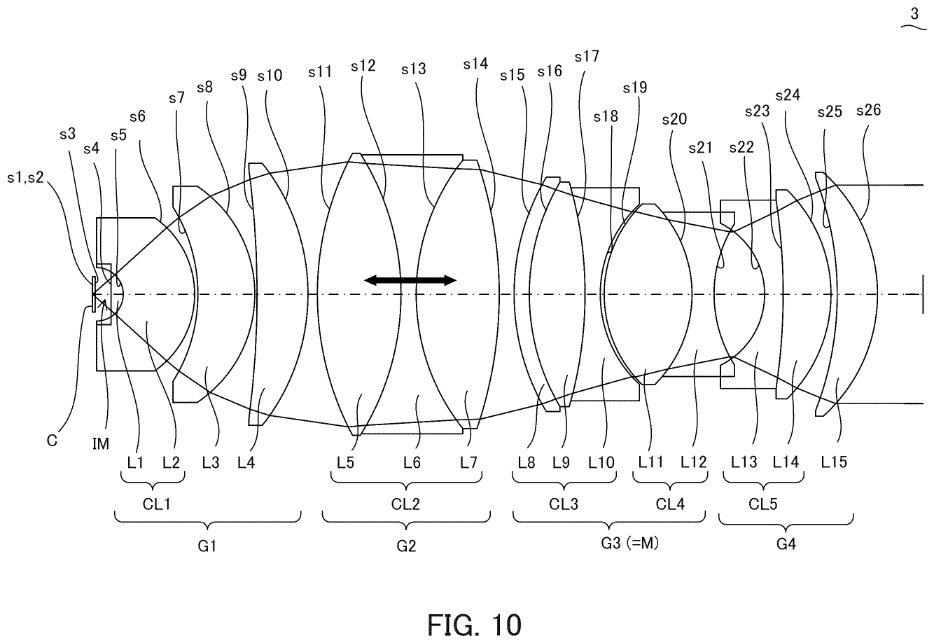

FIG. 10 is a cross-sectional view of an objective 3 according to the present example. The objective 3 is a liquid immersion objective for microscope. The objective 3 includes, in order from the object side, a first lens group G1 that has positive refractive power, a second lens group G2 that is moved along an optical axis and has positive refractive power, a third lens group G3, and a fourth lens group G4.

The first lens group G1 includes, in order from the object side, a cemented lens CL1, a lens L3 that is a meniscus lens having a concave surface facing the object side, and a lens L4 that is a meniscus lens having a concave surface facing the object side. The cemented lens CL1 is a two-lens cemented lens structured by cementing a lens L1 that is a positive lens having a flat surface facing the object side, that is, a positive lens having a convex surface facing the image side, and a lens L2 that is a meniscus lens having a concave surface facing the object side, and the cemented lens CL1 is a first lens component having positive refractive power.

The second lens group G2 includes a cemented lens CL2 that is moved along the optical axis. The cemented lens CL2 is a three-lens cemented lens structured by cementing a lens L5 that is a biconvex lens, a lens L6 that is a biconcave lens, and a lens L7 that is a biconvex lens.

The third lens group G3 includes, in order from the object side, a cemented lens CL3 and a cemented lens CL4. The cemented lens CL3 is a three-lens cemented lens in which a lens L8 that is a meniscus lens having a concave surface facing the image side, a lens L9 that is a biconvex lens, and a lens L10 that is a biconcave lens are cemented. The cemented lens CL4 is a two-lens cemented lens in which a lens L11 that is a biconvex lens and a lens L12 that is a biconcave lens are cemented. A lens group including the cemented lens CL3 and the cemented lens CL4 is the lens group M which has a convex surface closest to the object side and a concave surface closest to the image side and includes two positive lenses and three negative lenses, and in which adjacent lenses satisfy Conditional Expressions (1) and (2) as will be described below.

The fourth lens group G4 includes, in order from the object side, a cemented lens CL5 and a lens L15 that is a meniscus lens having a concave surface facing the object side. The cemented lens CL5 is a two-lens cemented lens structured by cementing a lens L13 that is a meniscus lens having a concave surface facing the object side and a lens L14 that is a meniscus lens having a concave surface facing the object side.

Various items of data of the objective 3 are as follows.

NA=1.0, f=7.206 mm, f_{G1}=10.015 mm, f_{G2}=26.448 mm, f_{G3}=−21.929 mm, f_{G4}=198.207 mm, R1=8.11662 mm, R2=8.33426 mm, d=0.260 mm, t1=5.669 mm, t2=7.232 mm, Φ_{L}=15.80 mm, TL=50.450 mm

Lens data of the objective 3 is as follows.

### Objective Lens 3

s r d nd νd
1 INF 0 nᵢₘ νᵢₘ
2 INF 0.17 1.52397 54.41
3 INF D3 nᵢₘ νᵢₘ
4 INF 0.800 1.51633 64.14
5 −1.7620 4.700 1.88300 40.76
6 −6.1650 0.214
7 −10.8730 3.748 1.75500 52.32
8 −8.5919 0.150
9 −62.7543 3.349 1.49700 81.54
10 −13.8974 D10
11 19.8220 5.506 1.56907 71.30
12 −17.4302 1.000 1.63775 42.41
13 14.2882 5.467 1.56907 71.30
14 −27.3208 D14
15 15.1235 1.000 1.63775 42.41
16 14.5813 3.669 1.49700 81.54
17 −26.9274 1.000 1.63775 42.41
18 8.1166 0.260
19 8.3343 5.783 1.56907 71.30
20 −8.4550 1.448 1.63775 42.41
21 8.7105 3.331
22 −5.2169 1.218 1.73800 32.33
23 −41.7045 3.152 1.49700 81.54
24 −9.6199 0.411
25 −21.4082 2.650 1.85478 24.80
26 −10.8145 110.000

In the observation performed by using the objective 3, the immersion liquid IM to be used is changed depending on the refractive index of the object, and the second lens group G2 is moved so that the aberrations are corrected. A first state, a second state, and a third state to be described below are states in which the second lens group G2 has been moved depending on respective different immersion liquids. In each state, the refractive index nᵢₘ and the Abbe number νᵢₘ of the immersion liquid, and D3, D10, and D14 that are values (unit: mm) of spacings d3, d10, and d14 in the lens data are as follows.
First state Second state Third state
nᵢₘ 1.51495 1.40000 1.56000
νᵢₘ 41.0 45.5 39.5
D3 1.051 0.979 1.079
D10 0.616 1.395 0.350
D14 0.979 0.200 1.245

The objective 3 satisfies Conditional Expressions (1) to (4) as will be described below.

|1/R1−1/R2|×(t1+t2)=0.04 (1)

d/(t1+t2)=0.02 (2)

Φ_{L}/TL=0.31 (3)

NA×WD=0.98 mm (4)
(*) The minimum value of WD is 0.979 mm in the second state.

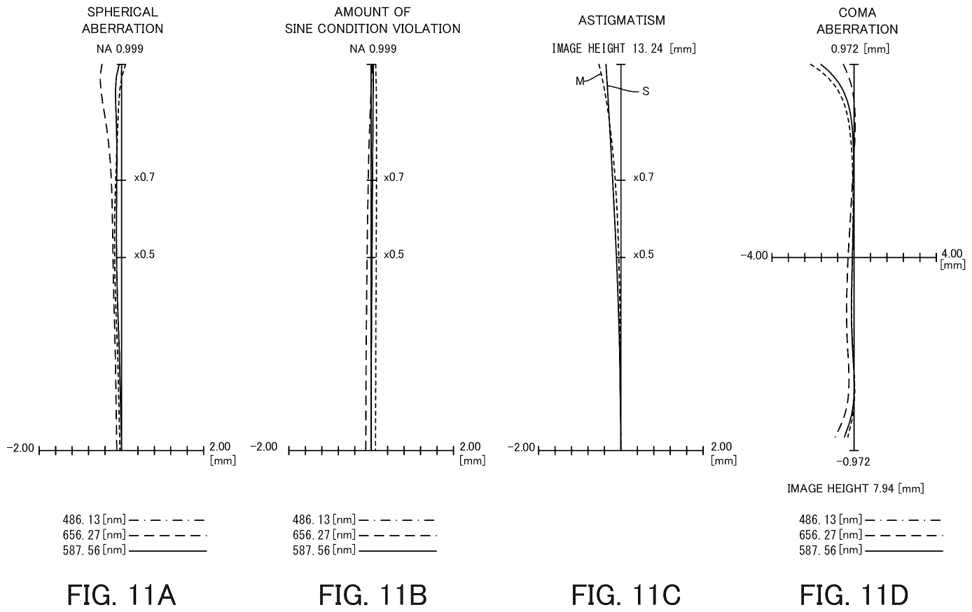

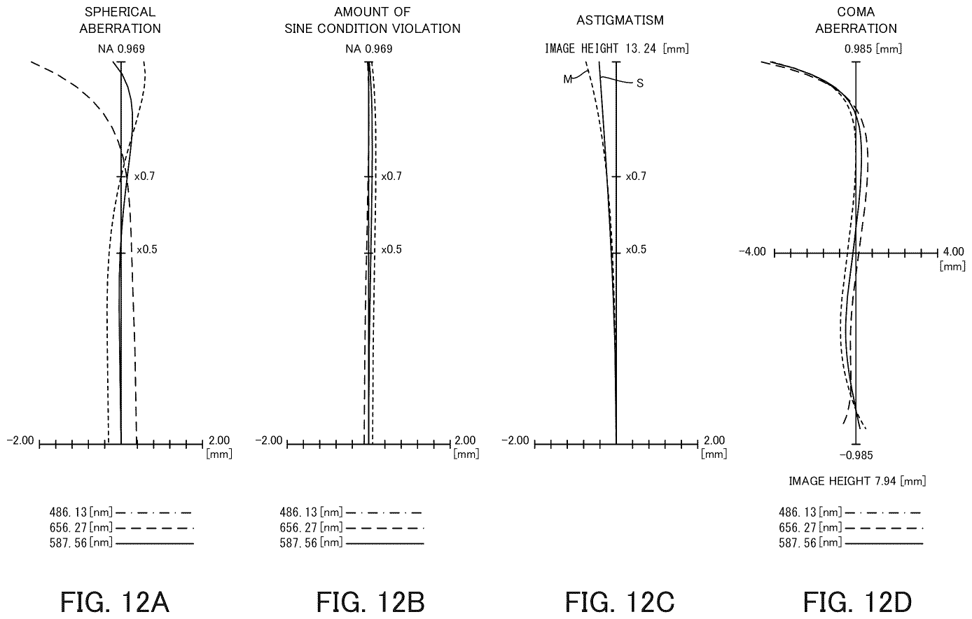

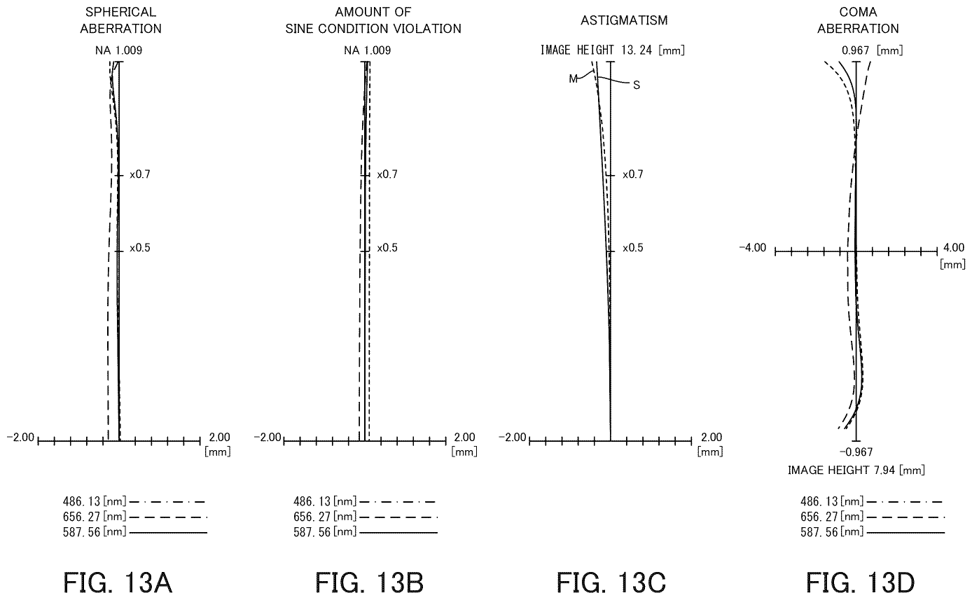

FIGS. 11A to 13D are aberration diagrams of an optical system including the objective and the imaging lens 10 and illustrate aberrations at an image plane formed by the objective 3 and the imaging lens 10 in the first state, the second state, and the third state, respectively. FIGS. 11A, 12A, and 13A are spherical aberration diagrams. FIGS. 11B, 12B, and 13B are diagrams illustrating the amounts of sine condition violation. FIGS. 11C, 12C, and 13C are astigmatism diagrams. FIGS. 11D, 12D, and 13D are coma aberration diagrams at the image height ratio of 0.6 (the image height of 7.94 mm). As illustrated in FIGS. 11A to 13D, in the present example, the aberrations are favorably corrected regardless of the immersion liquid in the case of using the immersion liquid depending on a refractive index of an object.

### EXAMPLE 4

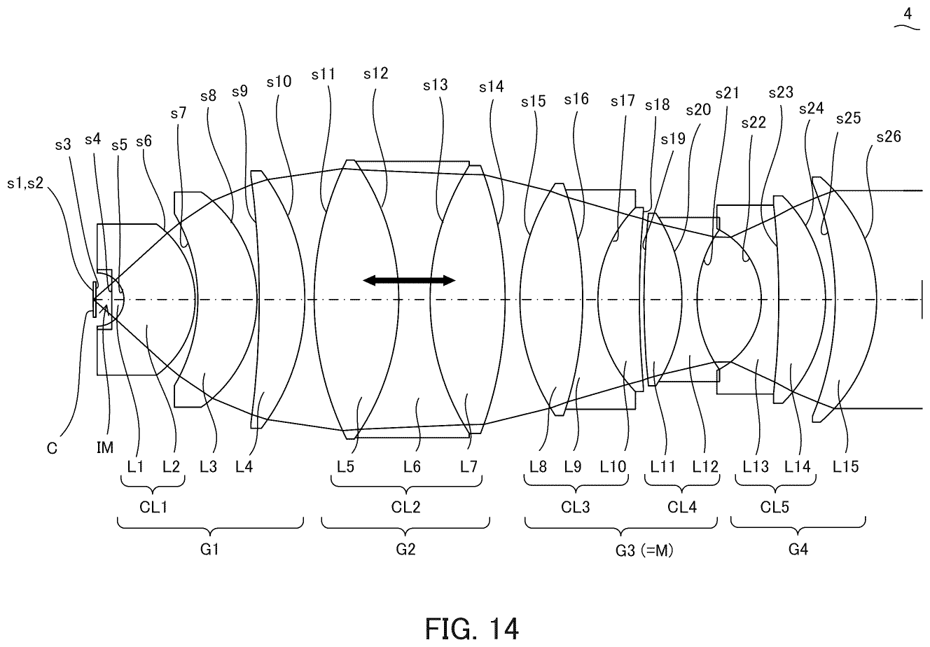

FIG. 14 is a cross-sectional view of an objective 4 according to the present example. The objective 4 is a liquid immersion objective for microscope. The objective 4 includes, in order from the object side, a first lens group G1 that has positive refractive power, a second lens group G2 that is moved along an optical axis and has positive refractive power, a third lens group G3, and a fourth lens group G4.

The first lens group G1 includes, in order from the object side, a cemented lens CL1, a lens L3 that is a meniscus lens having a concave surface facing the object side, and a lens L4 that is a meniscus lens having a concave surface facing the object side. The cemented lens CL1 is a two-lens cemented lens in which a lens L1 that is a positive lens having a flat surface facing the object side, that is, a positive lens having a convex surface facing the image side, and a lens L2 that is a meniscus lens having a concave surface facing the object side are cemented, and the cemented lens CL1 is a first lens component having positive refractive power.

The second lens group G2 includes a cemented lens CL2 that is moved along the optical axis. The cemented lens CL2 is a three-lens cemented lens in which a lens L5 that is a biconvex lens, a lens L6 that is a biconcave lens, and a lens L7 that is a biconvex lens are cemented.

The third lens group G3 includes, in order from the object side, a cemented lens CL3 and a cemented lens CL4. The cemented lens CL3 is a three-lens cemented lens in which a lens L8 that is a biconvex lens, a lens L9 that is a biconcave lens, and a lens L10 that is a meniscus lens having a concave surface facing the image side are cemented. The cemented lens CL4 is a two-lens cemented lens in which a lens L11 that is a biconvex lens and a lens L12 that is a biconcave lens are cemented. A lens group including the cemented lens CL3 and the cemented lens CL4 is the lens group M which has a convex surface closest to the object side and a concave surface closest to the image side and includes three positive lenses and two negative lenses, and in which adjacent lenses satisfy Conditional Expressions (1) and (2) as will be described below.

The fourth lens group G4 includes, in order from the object side, a cemented lens CL5 and a lens L15 that is a meniscus lens having a concave surface facing the object side. The cemented lens CL5 is a two-lens cemented lens structured by cementing a lens L13 that is a meniscus lens having a concave surface facing the object side and a lens L14 that is a meniscus lens having a concave surface facing the object side.

Various items of data of the objective 4 are as follows.

NA=1.0, f=7.205 mm, f_{G1}=9.981 mm, f_{G2}=26.221 mm, f_{G3}=−23.438 mm, f_{G4}=364.273 mm, R1=64.39925 mm, R2=55.4218 mm, d=0.300 mm, t1=7.885 mm, t2=3.505 mm, Φ_{L}=16.00 mm, TL=50.468 mm

Lens data of the objective 4 is as follows.

### Objective Lens 4

s r d nd νd
1 INF 0 nᵢₘ νᵢₘ
2 INF 0.17 1.52397 54.41
3 INF D3 nᵢₘ νᵢₘ
4 INF 0.800 1.51633 64.14
5 −1.7620 4.700 1.88300 40.76
6 −6.1650 0.177
7 −11.2041 3.904 1.75500 52.32
8 −8.7180 0.153
9 −60.3389 3.003 1.49700 81.54
10 −14.0279 D10
11 20.9139 5.585 1.56907 71.30
12 −15.9680 2.066 1.63775 42.41
13 16.4256 4.952 1.56907 71.30
14 −25.0134 D14
15 13.7526 4.146 1.49700 81.54
16 −23.7378 1.000 1.63775 42.41
17 8.7109 2.739 1.56907 71.30
18 64.3993 0.300
19 55.4218 2.505 1.56907 71.30
20 −10.3392 1.000 1.63775 42.41
21 7.9988 4.242
22 −5.2149 1.153 1.73800 32.33
23 −57.1879 3.083 1.49700 81.54
24 −9.6967 0.646
25 −20.5085 2.728 1.85478 24.80
26 −10.6841 110.000

In the observation performed by using the objective 4, the immersion liquid IM to be used is changed depending on the refractive index of the object, and the second lens group G2 is moved so that the aberrations are corrected. A first state, a second state, and a third state to be described below are states in which the second lens group G2 has been moved depending on respective different immersion liquids. In each state, the refractive index nᵢₘ and the Abbe number νᵢₘ of the immersion liquid, and D3, D10, and D14 that are values (unit: mm) of spacings d3, d10, and d14 in the lens data are as follows.
First state Second state Third state
nᵢₘ 1.51495 1.40000 1.56000
νᵢₘ 41.0 45.5 39.5
D3 1.051 0.979 1.079
D10 0.614 1.387 0.350
D14 0.973 0.200 1.237

The objective 4 satisfies Conditional Expressions (1) to (4) as will be described below.

|1/R1−1/R2|×(t1+t2)=0.03 (1)

d/(t1+t2)=0.03 (2)

Φ_{L}/TL=0.32 (3)

NA×WD=0.98 mm (4)
(*) The minimum value of WD is 0.979 mm in the second state.

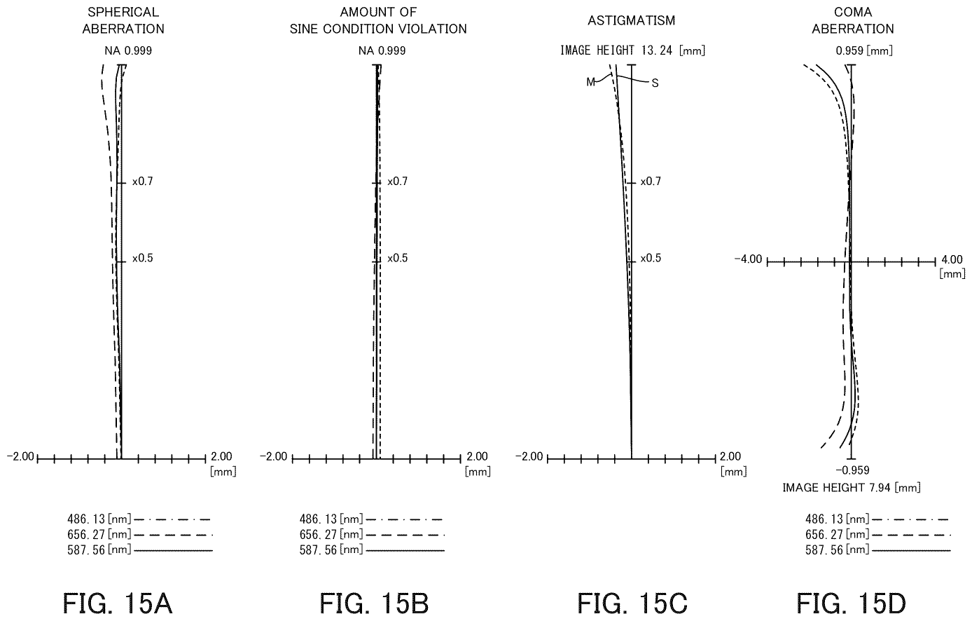

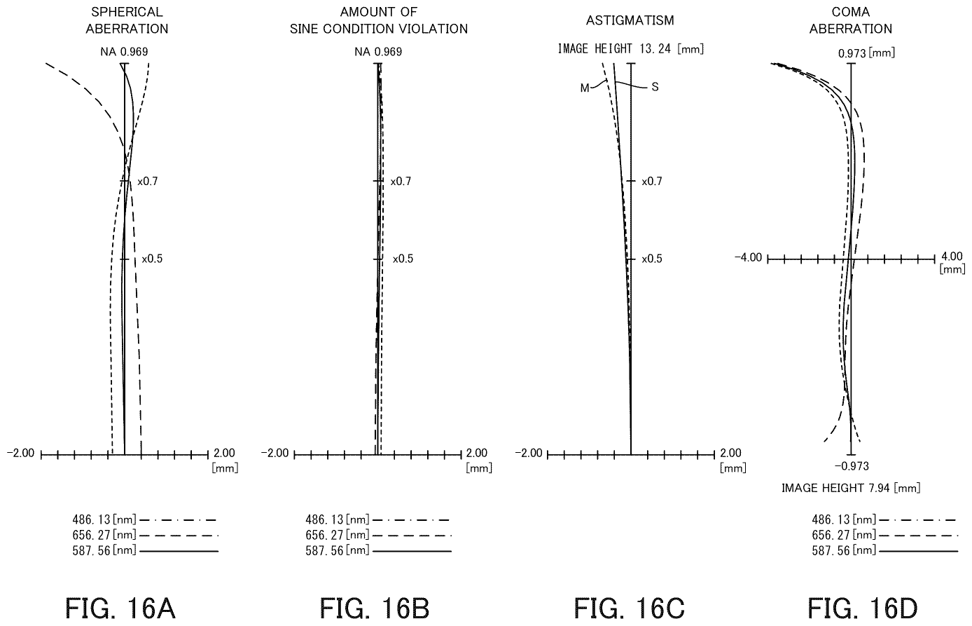

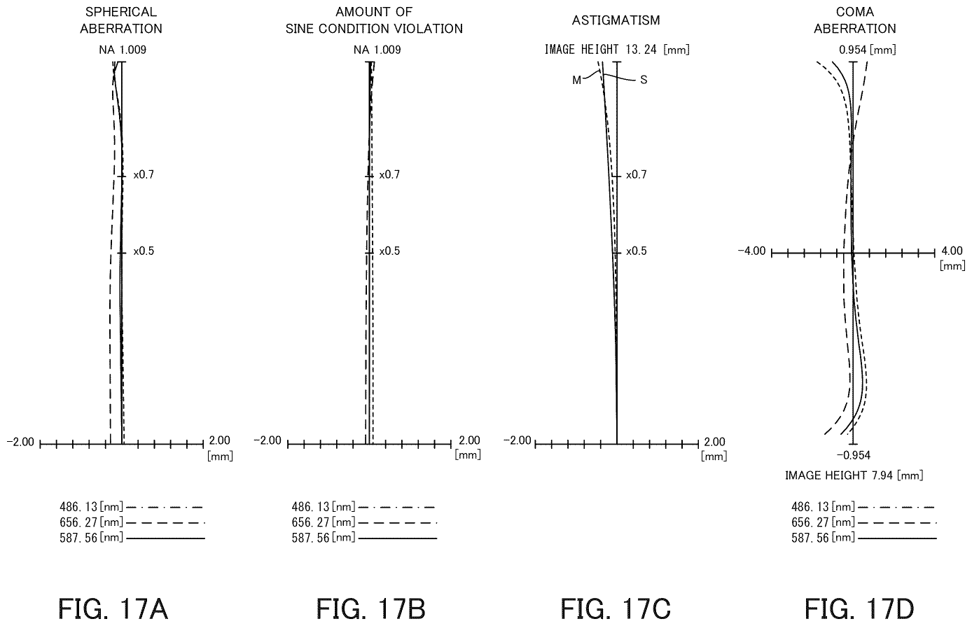

FIGS. 15A to 17D are aberration diagrams of an optical system including the objective 4 and the imaging lens 10 and illustrate aberrations at an image plane formed by the objective 4 and the imaging lens 10 in the first state, the second state, and the third state, respectively. FIGS. 15A, 16A, and 17A are spherical aberration diagrams. FIGS. 15B, 16B, and 17B are diagrams illustrating the amounts of sine condition violation. FIGS. 15C, 16C, and 17C are astigmatism diagrams. FIGS. 15D, 16D, and 17D are coma aberration diagrams at the image height ratio of 0.6 (the image height of 7.94 mm). As illustrated in FIGS. 15A to 17D, in the present example, the aberrations are favorably corrected regardless of the immersion liquids in the case of using the immersion liquids depending on a refractive index of an object.

### EXAMPLE 5

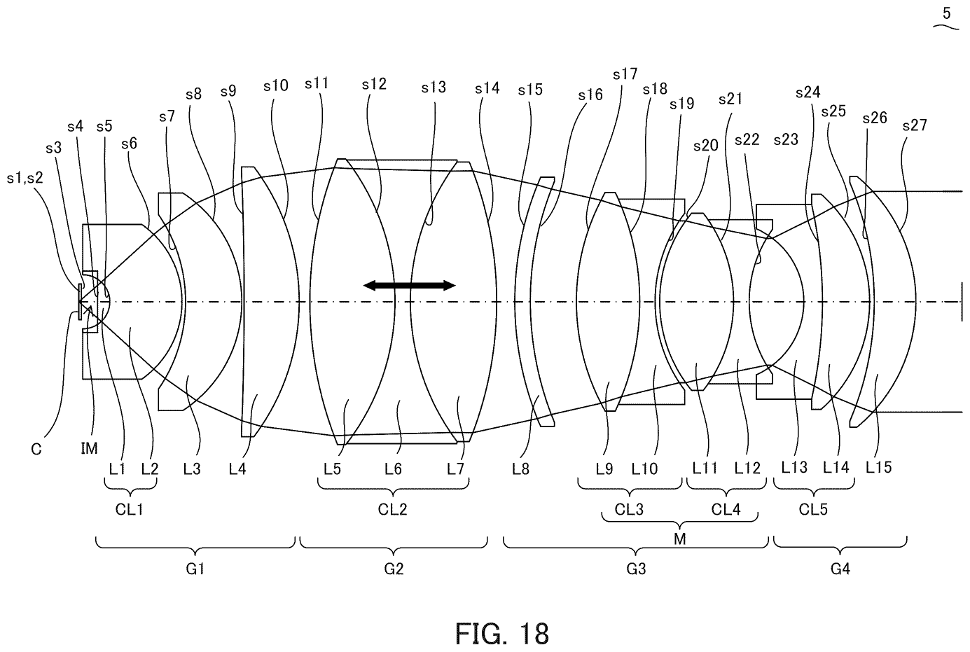

FIG. 18 is a cross-sectional view of an objective 5 according to the present example. The objective 5 is a liquid immersion objective for microscope. The objective 5 includes, in order from the object side, a first lens group G1 that has positive refractive power, a second lens group G2 that is moved along an optical axis and has positive refractive power, a third lens group G3, and a fourth lens group G4.

The first lens group G1 includes, in order from the object side, a cemented lens CL1, a lens L3 that is a meniscus lens having a concave surface facing the object side, and a lens L4 that is a meniscus lens having a concave surface facing the object side. The cemented lens CL1 is a two-lens cemented lens in which a lens L1 that is a positive lens having a flat surface facing the object side, that is, a positive lens having a convex surface facing the image side, and a lens L2 that is a meniscus lens having a concave surface facing the object side are cemented, and the cemented lens CL1 is a first lens component having positive refractive power.

The second lens group G2 includes a cemented lens CL2 that is moved along the optical axis. The cemented lens CL2 is a three-lens cemented lens in which a lens L5 that is a biconvex lens, a lens L6 that is a biconcave lens, and a lens L7 that is a biconvex lens are cemented.

The third lens group G3 includes, in order from the object side, a lens L8 that is a meniscus lens having a concave surface facing the image side, a cemented lens CL3, and a cemented lens CL4. The cemented lens CL3 is a two-lens cemented lens in which a lens L9 that is a biconvex lens and a lens L10 that is a biconcave lens are cemented. The cemented lens CL4 is a two-lens cemented lens in which a lens L11 that is a biconvex lens and a lens L12 that is a biconcave lens are cemented. A lens group including the cemented lens CL3 and the cemented lens CL4 is the lens group M which has a convex surface closest to the object side and a concave surface closest to the image side and includes two positive lenses and two negative lenses and in which adjacent lenses satisfy Conditional Expressions (1) and (2) as will be described below. That is, the third lens group G3 includes the lens L8 and the lens group M.

The fourth lens group G4 includes, in order from the object side, a cemented lens CL5 and a lens L15 that is a meniscus lens having a concave surface facing the object side. The cemented lens CL5 is a two-lens cemented lens structured by cementing a lens L13 that is a meniscus lens having a concave surface facing the object side and a lens L14 that is a meniscus lens having a concave surface facing the object side.

Various items of data of the objective 5 are as follows.

NA=1.0, f=7.208 mm, f_{G1}=9.853 mm, f_{G2}=28.872 mm, f_{G3}=−22.621 mm, f_{G4}=165.226 mm, R1=9.61748 mm, R2=9.07224 mm, d=0.300 mm, t1=5.123 mm, t2=5.827 mm, Φ_{L}=16.20 mm, TL=53.283 mm

Lens data of the objective 5 is as follows.

### Objective Lens 5

s r d nd νd
1 INF 0 nᵢₘ νᵢₘ
2 INF 0.17 1.52397 54.41
3 INF D3 nᵢₘ νᵢₘ
4 INF 0.800 1.51633 64.14
5 −1.7620 4.700 1.88300 40.76
6 −6.1650 0.231
7 −10.0655 3.664 1.75500 52.32
8 −8.4691 0.150
9 −216.5442 3.587 1.49700 81.54
10 −14.5855 D10
11 24.9805 5.545 1.56907 71.30
12 −15.1232 1.000 1.63775 42.41
13 15.1810 5.620 1.56907 71.30
14 −24.1935 D14
15 20.4949 1.012 1.63775 42.41
16 20.4052 3.000
17 14.5116 4.123 1.49700 81.54
18 −16.7589 1.000 1.63775 42.41
19 9.6175 0.300
20 9.0722 4.809 1.56907 71.30
21 −9.4490 1.018 1.63775 42.41
22 8.1150 3.559
23 −5.2066 1.209 1.73800 32.33
24 −28.8031 3.073 1.49700 81.54
25 −9.3670 0.300
26 −19.7923 2.714 1.85478 24.80
27 −10.6226 110.000

In the observation performed by using the objective 5, the immersion liquid IM to be used is changed depending on the refractive index of the object, and the second lens group G2 is moved so that the aberrations are corrected. A first state, a second state, and a third state to be described below are states in which the second lens group G2 has been moved depending on respective different immersion liquids. In each state, the refractive index nᵢₘ and the Abbe number νᵢₘ of the immersion liquid, and D3, D10, and D14 that are values (unit: mm) of spacings d3, d10, and d14 in the lens data are as follows.
First state Second state Third state
nᵢₘ 1.51495 1.40000 1.56000
νᵢₘ 41.0 45.5 39.5
D3 1.051 0.980 1.078
D10 0.692 1.670 0.350
D14 1.178 0.200 1.520

The objective 5 satisfies Conditional Expressions (1) to (4) as will be described below.

|1/R1−1/R2|×(t1+t2)=0.07 (1)

d/(t1+t2)=0.03 (1)

Φ_{L}/TL=0.30 (1)

NA×WD=0.98 mm (1)
(*) The minimum value of WD is 0.980 mm in the second state.

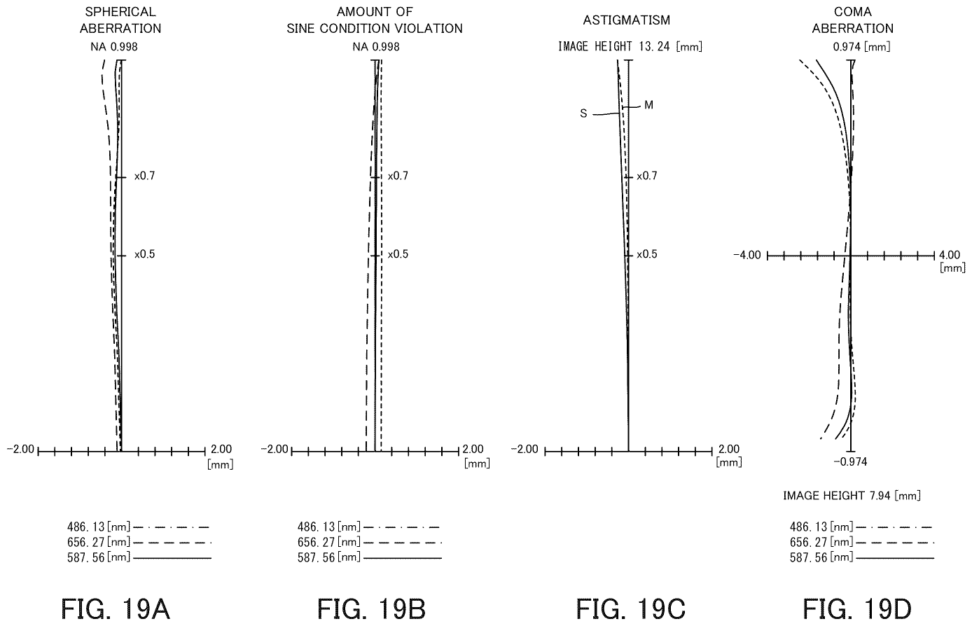

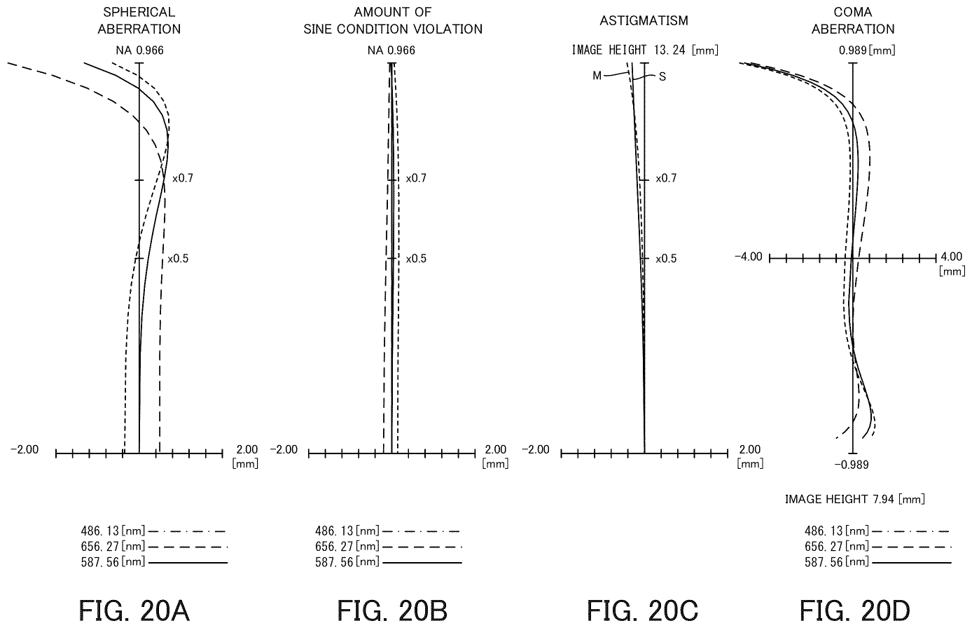

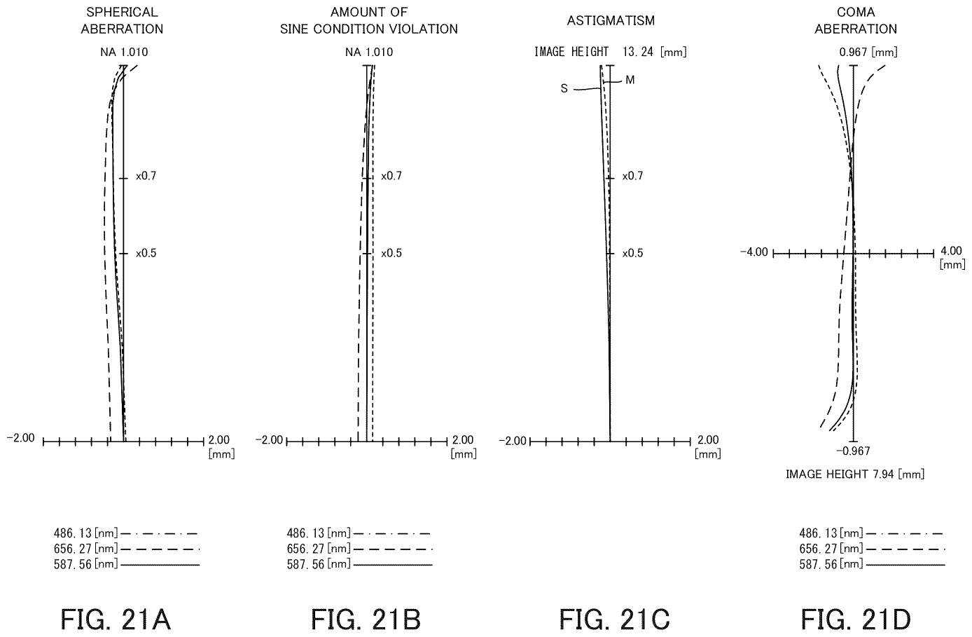

FIGS. 19A to 21D are aberration diagrams of an optical system including the objective 5 and the imaging lens 10 and illustrate aberrations at an image plane formed by the objective 5 and the imaging lens 10 in the first state, the second state, and the third state, respectively. FIGS. 19A, 20A, and 21A are spherical aberration diagrams. FIGS. 19B, 20B, and 21B are diagrams illustrating the amounts of sine condition violation. FIGS. 19C, 20C, and 21C are astigmatism diagrams. FIGS. 19D, 20D, and 21D are coma aberration diagrams at the image height ratio of 0.6 (the image height of 7.94 mm). As illustrated in FIGS. 19A to 21D, in the present example, the aberrations are favorably corrected regardless of the immersion liquids in the case of using the immersion liquids depending on a refractive index of an object.

### EXAMPLE 6

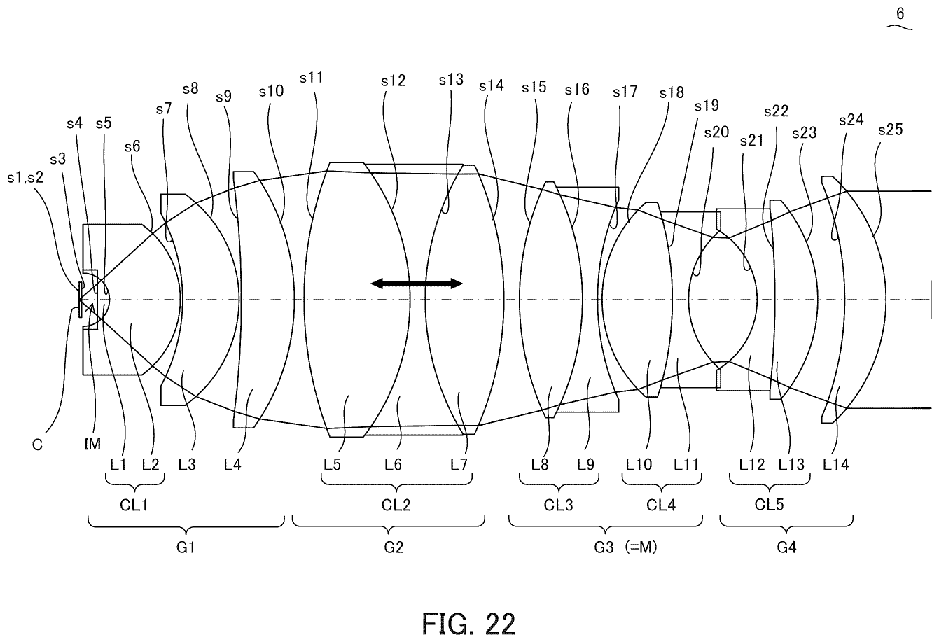

FIG. 22 is a cross-sectional view of an objective 6 according to the present example. The objective 6 is a liquid immersion objective for microscope. The objective 6 includes, in order from the object side, a first lens group G1 that has positive refractive power, a second lens group G2 that is moved along an optical axis and has positive refractive power, a third lens group G3, and a fourth lens group G4.

The first lens group G1 includes, in order from the object side, a cemented lens CL1, a lens L3 that is a meniscus lens having a concave surface facing the object side, and a lens L4 that is a meniscus lens having a concave surface facing the object side. The cemented lens CL1 is a two-lens cemented lens in which a lens L1 that is a positive lens having a flat surface facing the object side, that is, a positive lens having a convex surface facing the image side, and a lens L2 that is a meniscus lens having a concave surface facing the object side are cemented, and the cemented lens CL1 is a first lens component having positive refractive power.

The second lens group G2 includes a cemented lens CL2 that is moved along the optical axis. The cemented lens CL2 is a three-lens cemented lens in which a lens L5 that is a biconvex lens, a lens L6 that is a biconcave lens, and a lens L7 that is a biconvex lens are cemented.

The third lens group G3 includes, in order from the object side, a cemented lens CL3 and a cemented lens CL4. The cemented lens CL3 is a two-lens cemented lens in which a lens L8 that is a biconvex lens and a lens L9 that is a biconcave lens are cemented. The cemented lens CL4 is a two-lens cemented lens in which a lens L10 that is a biconvex lens and a lens L11 that is a biconcave lens are cemented. A lens group including the cemented lens CL3 and the cemented lens CL4 is the lens group M which has a convex surface closest to the object side and a concave surface closest to the image side and includes two positive lenses and two negative lenses and in which adjacent lenses satisfy Conditional Expressions (1) and (2) as will be described below.

The fourth lens group G4 includes, in order from the object side, a cemented lens CL5 and a lens L14 that is a meniscus lens having a concave surface facing the object side. The cemented lens CL5 is a two-lens cemented lens structured by cementing a lens L12 that is a meniscus lens having a concave surface facing the object side and a lens L13 that is a meniscus lens having a concave surface facing the object side.

Various items of data of the objective 6 are as follows.

NA=1.0, f=7.204 mm, f_{G1}=9.729 mm, f_{G2}=26.788 mm, f_{G3}=−26.794 mm, f_{G4}=−989.85 mm, R1=16.3320 mm, R2=8.60366 mm, d=0.300 mm, t1=5.182 mm, t2=5.742 mm, Φ_{L}=16.20 mm, TL=52.345 mm

Lens data of the objective 6 is as follows.

### Objective Lens 6

s r d nd νd
1 INF 0 nᵢₘ νᵢₘ
2 INF 0.17 1.52397 54.41
3 INF D3 nᵢₘ νᵢₘ
4 INF 0.800 1.51633 64.14
5 −1.7620 4.700 1.88300 40.76
6 −6.1650 0.150
7 −12.0599 3.750 1.75500 52.32
8 −8.6343 0.150
9 −61.4506 3.525 1.49700 81.54
10 −14.6925 D10
11 24.9298 7.044 1.56907 71.30
12 −14.8897 1.000 1.63775 42.41
13 17.0775 5.227 1.56907 71.30
14 −21.4158 D14
15 18.4949 4.182 1.49700 81.54
16 −16.9662 1.000 1.63775 42.41
17 16.3320 0.300
18 8.6037 4.672 1.56907 71.30
19 −21.5979 1.070 1.63775 42.41
20 6.1208 4.556
21 −5.4064 1.181 1.73800 32.33
22 −55.5245 2.842 1.49700 81.54
23 −10.0874 1.792
24 -20.5660 2.738 1.85478 24.80
25 −11.2360 110.000

In the observation performed by using the objective 6, the immersion liquid IM to be used is changed depending on the refractive index of the object, and the second lens group G2 is moved so that the aberrations are corrected. A first state, a second state, and a third state to be described below are states in which the second lens group G2 has been moved depending on respective different immersion liquids. In each state, the refractive index nᵢₘ and the Abbe number νᵢₘ of the immersion liquid, and D3, D10, and D14 that are values (unit: mm) of spacings d3, d10, and d14 in the lens data are as follows.
First state Second state Third state
nᵢₘ 1.51495 1.40000 1.56000
νᵢₘ 41.0 45.5 39.5
D3 1.051 0.984 1.078
D10 0.634 1.466 0.350
D14 1.033 0.200 1.316

The objective 6 satisfies the conditional expressions (1) to (4) as will be described below.

|1/R1−1/R2|×(t1+t2)=0.60 (1)

d/(t1+t2)=0.03 (1)

Φ_{L}/TL=0.31 (1)

NA×WD=0.98 mm (1)
(*) The minimum value of WD is 0.984 mm in the second state.

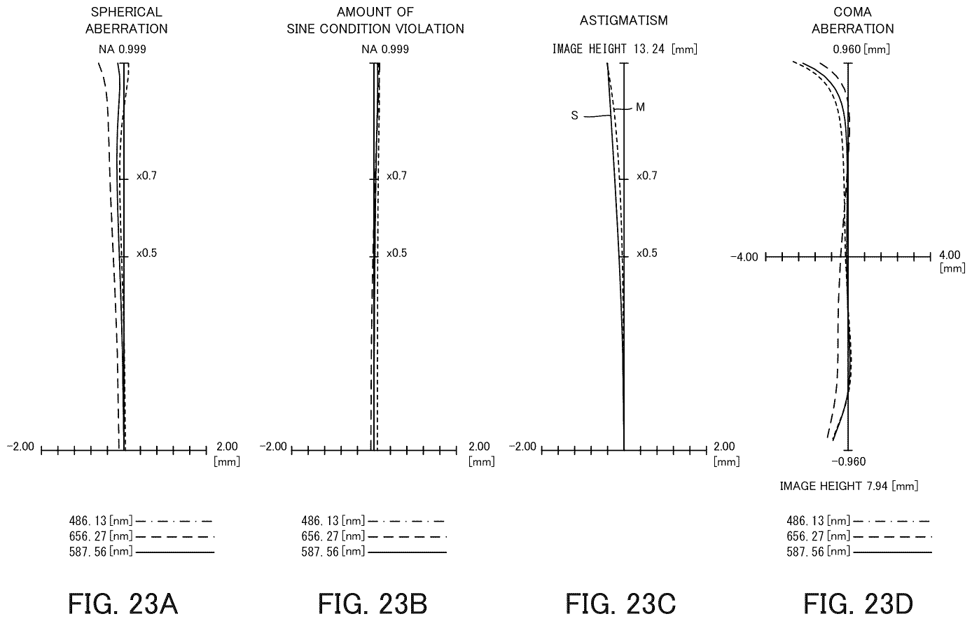

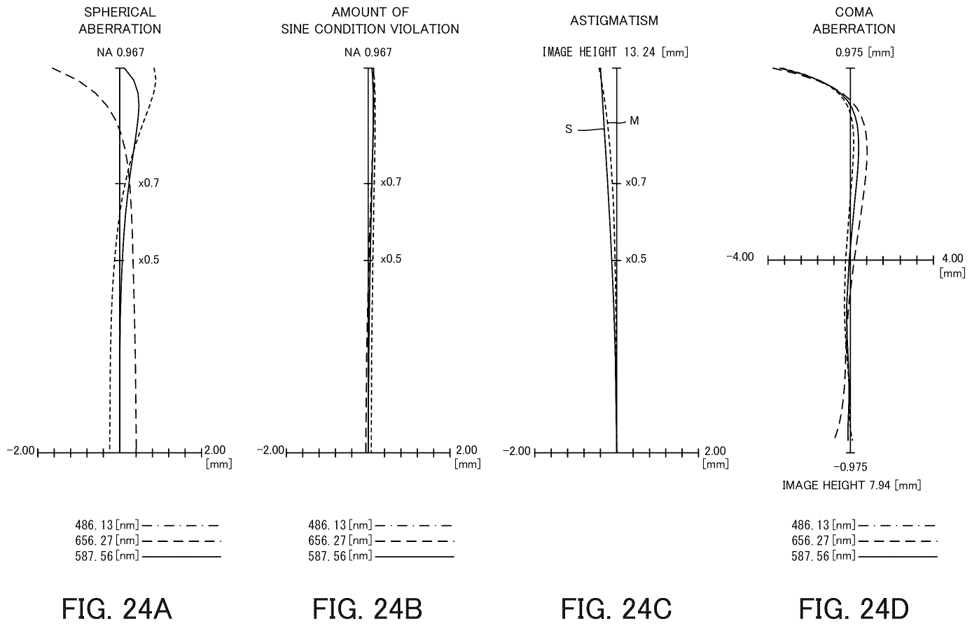

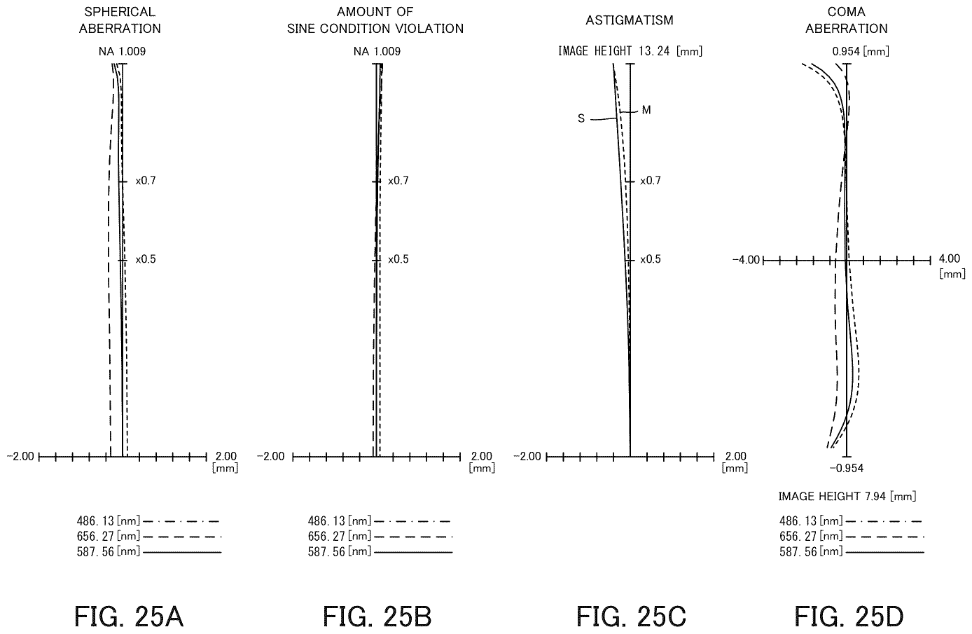

FIGS. 23A to 25D are aberration diagrams of an optical system including the objective and the imaging lens 10 and illustrate aberrations at an image plane formed by the objective 6 and the imaging lens 10 in the first state, the second state, and the third state, respectively. FIGS. 23A, 24A, and 25A are spherical aberration diagrams. FIGS. 23B, 24B, and 25B are diagrams illustrating the amounts of sine condition violation. FIGS. 23C, 24C, and 25C are astigmatism diagrams. FIGS. 23D, 24D, and 25D are coma aberration diagrams at the image height ratio of 0.6 (the image height of 7.94 mm). As illustrated in FIGS. 23A to 25D, in the present example, the aberrations are favorably corrected regardless of the immersion liquids in the case of using the immersion liquids depending on a refractive index of an object.

### EXAMPLE 7

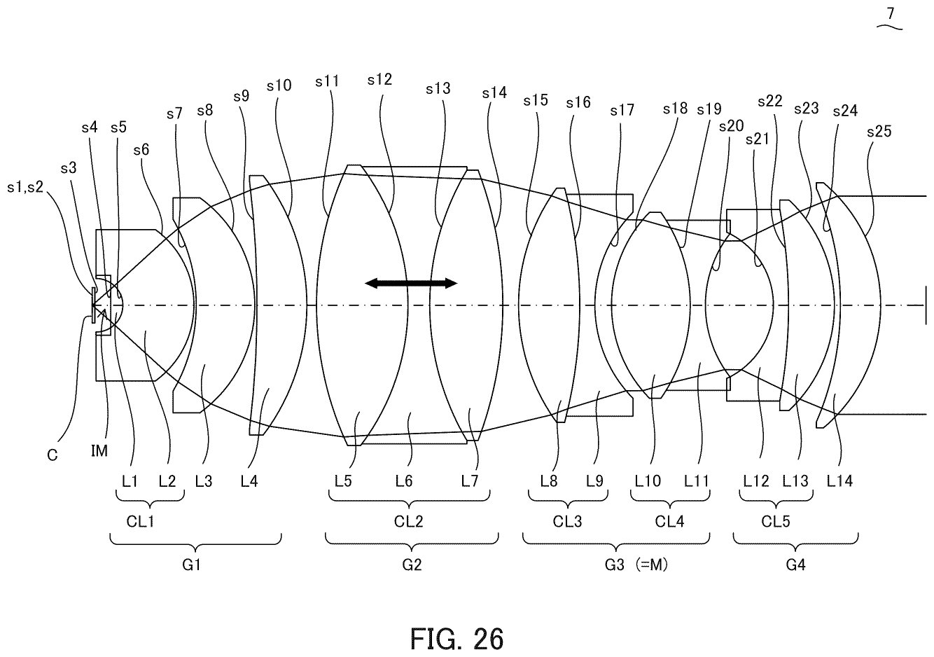

FIG. 26 is a cross-sectional view of an objective 7 according to the present example. The objective 7 is a liquid immersion objective for microscope. The objective 7 includes, in order from the object side, a first lens group G1 that has positive refractive power, a second lens group G2 that is moved along an optical axis and has positive refractive power, a third lens group G3, and a fourth lens group G4.

The first lens group G1 includes, in order from the object side, a cemented lens CL1, a lens L3 that is a meniscus lens having a concave surface facing the object side, and a lens L4 that is a meniscus lens having a concave surface facing the object side. The cemented lens CL1 is a two-lens cemented lens in which a lens L1 that is a positive lens having a flat surface facing the object side, that is, a positive lens having a convex surface facing the image side, and a lens L2 that is a meniscus lens having a concave surface facing the object side are cemented, and the cemented lens CL1 is a first lens component having positive refractive power.

The second lens group G2 includes a cemented lens CL2 that is moved along the optical axis. The cemented lens CL2 is a three-lens cemented lens in which a lens L5 that is a biconvex lens, a lens L6 that is a biconcave lens, and a lens L7 that is a biconvex lens are cemented.

The third lens group G3 includes, in order from the object side, a cemented lens CL3 and a cemented lens CL4. The cemented lens CL3 is a two-lens cemented lens in which a lens L8 that is a biconvex lens and a lens L9 that is a biconcave lens are cemented. The cemented lens CL4 is a two-lens cemented lens in which a lens L10 that is a biconvex lens and a lens L11 that is a biconcave lens are cemented. A lens group including the cemented lens CL3 and the cemented lens CL4 is the lens group M which has a convex surface closest to the object side and a concave surface closest to the image side and includes two positive lenses and two negative lenses and in which adjacent lenses satisfy Conditional Expressions (1) and (2) as will be described below.

The fourth lens group G4 includes, in order from the object side, a cemented lens CL5 and a lens L14 that is a meniscus lens having a concave surface facing the object side. The cemented lens CL5 is a two-lens cemented lens structured by cementing a lens L12 that is a meniscus lens having a concave surface facing the object side and a lens L13 that is a meniscus lens having a concave surface facing the object side.

Various items of data of the objective 7 are as follows.

NA=1.0, f=7.206 mm, f_{G1}=9.926mm, f_{G2} =26.88 mm, f_{G3}=−23.388 mm, f_{G4}=239.987 mm, R1=8.74104 mm, R2=8.75022 mm, d=1.100 mm, t1=5.041 mm, t2=6.204 mm, Φ_{L}=16.00 mm, TL=50.876 mm

Lens data of the objective 7 is as follows.

### Objective Lens 7

s r d nd νd
1 INF 0 nᵢₘ νᵢₘ
2 INF 0.17 1.52397 54.41
3 INF D3 nᵢₘ νᵢₘ
4 INF 0.800 1.51633 64.14
5 −1.7620 4.700 1.88300 40.76
6 −6.1650 0.150
7 −11.2499 3.873 1.75500 52.32
8 −8.7381 0.150
9 −67.5316 3.290 1.49700 81.54
10 −14.1156 D10
11 21.7866 6.046 1.56907 71.30
12 −15.2006 1.436 1.63775 42.41
13 17.4163 4.829 1.56907 71.30
14 −25.1519 D14
15 13.1159 4.041 1.49700 81.54
16 −30.4776 1.000 1.63775 42.41
17 8.7410 1.100
18 8.7502 5.204 1.56907 71.30
19 −10.6517 1.000 1.63775 42.41
20 7.6747 4.498
21 −5.3182 1.000 1.73800 32.33
22 −34.4206 3.030 1.49700 81.54
23 −9.5205 0.394
24 −19.4601 2.662 1.85478 24.80
25 −10.5287 110.000

In the observation performed by using the objective 7, the immersion liquid IM to be used is changed depending on the refractive index of the object, and the second lens group G2 is moved so that the aberrations are corrected. A first state, a second state, and a third state to be described below are states in which the second lens group G2 has been moved depending on respective different immersion liquids. In each state, the refractive index nᵢₘ and the Abbe number νᵢₘ of the immersion liquid, and D3, D10, and D14 that are values (unit: mm) of spacings d3, d10, and d14 in the lens data are as follows.
First state Second state Third state
nᵢₘ 1.51495 1.40000 1.56000
νᵢₘ 41.0 45.5 39.5
D3 1.051 0.982 1.079
D10 0.635 1.475 0.350
D14 1.039 0.200 1.325

The objective 7 satisfies Conditional Expressions (1) to (4) as will be described below.

|1/R1−1/R2|×(t1+t2)=0.00 (1)

d/(t1+t2)=0.10 (1)

Φ_{L}/TL=0.31 (1)

NA×WD=0.98 mm (1)
(*) The minimum value of WD is 0.982 mm in the second state.

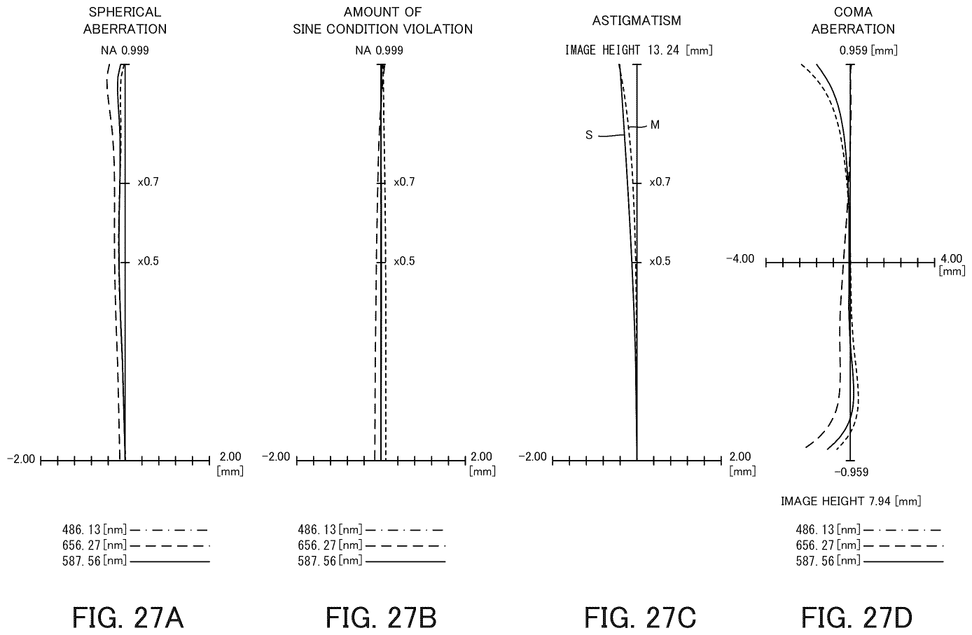

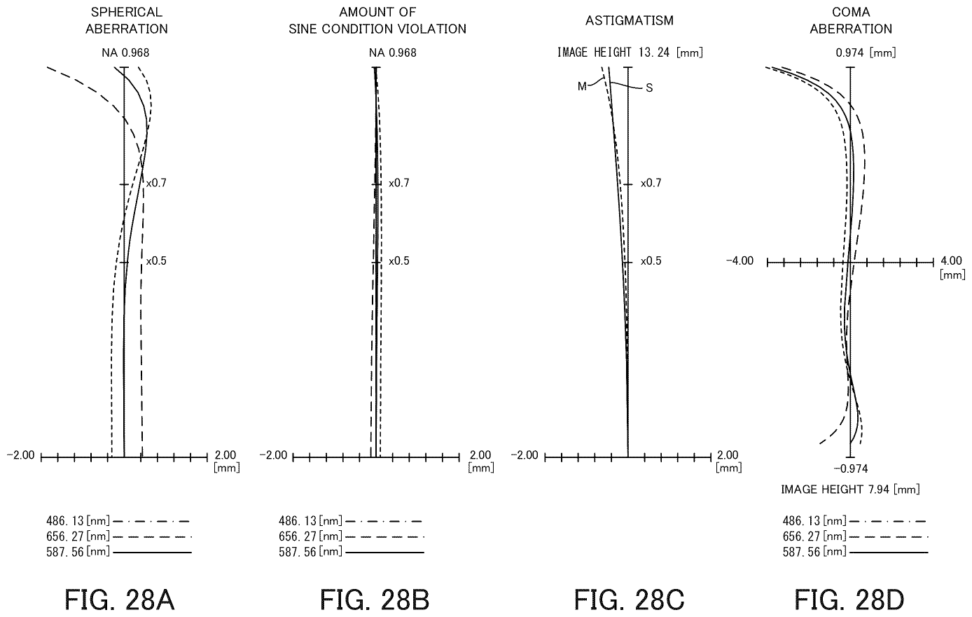

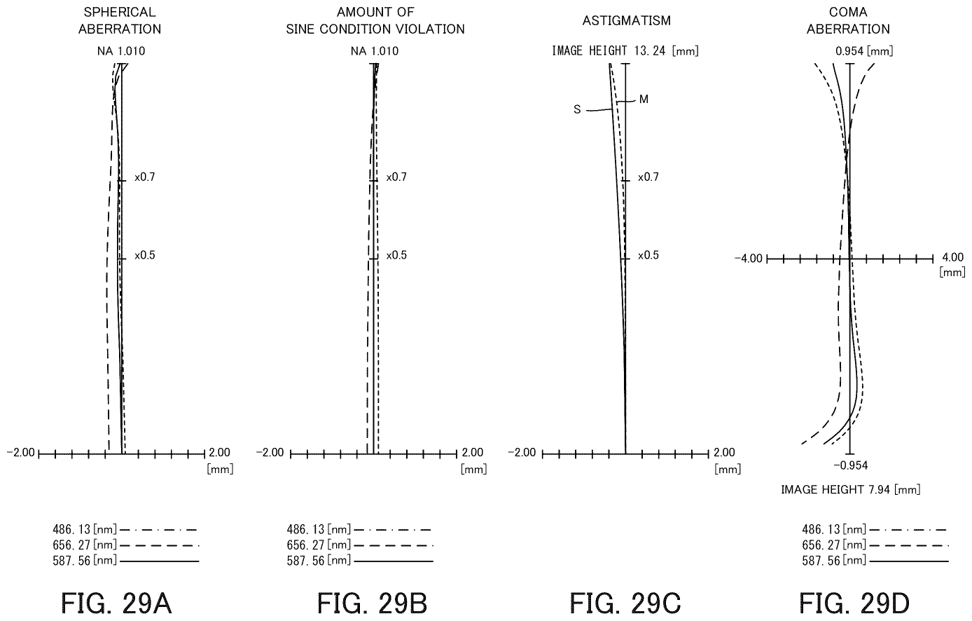

FIGS. 27A to 29D are aberration diagrams of an optical system including the objective 7 and the imaging lens 10 and illustrate aberrations at an image plane formed by the objective 7 and the imaging lens 10 in the first state, the second state, and the third state, respectively. FIGS. 27A, 28A, and 29A are spherical aberration diagrams. FIGS. 27B, 28B, and 29B are diagrams illustrating the amounts of sine condition violation. FIGS. 27C, 28C, and 29C are astigmatism diagrams. FIGS. 27D, 28D, and 29D are coma aberration diagrams at the image height ratio of 0.6 (the image height of 7.94 mm). As illustrated in FIGS. 27A to 29D, in the present example, the aberrations are favorably corrected regardless of the immersion liquids in the case of using the immersion liquids depending on a refractive index of an object.

What is claimed is:

1. An objective comprising: in order from an object side,
a first lens group that has positive refractive power;
a second lens group that is moved along an optical axis and has positive refractive power; and
a third lens group and a fourth lens group arranged so that concave surfaces adjacent to each other face each other, wherein
the third lens group includes
a lens group M including two or more positive lenses and two or more negative lenses in which a lens surface closest to the object side is a convex surface facing the object side and a lens surface closest to an image side is a concave surface facing the image side, and
the lens group M includes
adjacent lenses that are cemented or
adjacent lenses that are separated by an air layer, in which the following conditional expressions are satisfied:
0≤|1/R1−1/R2|×(t1+t2)≤0.8
0≤d/(t1+t2)≤0.2
here, R1 denotes a curvature radius of a lens surface on the object side of the air layer, R2 denotes a curvature radius of a lens surface on the image side of the air layer, d denotes a thickness of the air layer on an optical axis, t1 denotes a thickness of a lens component on the optical axis on the object side of the air layer, and t2 denotes a thickness of a lens component on the optical axis on the image side of the air layer.

2. The objective according to claim 1, wherein the following conditional expression is satisfied:
0.15≤Φ_{L}/TL≤0.8
here, Φ_{L} denotes a lens outer diameter of a lens closest to the image side in the objective, and TL denotes a distance on the optical axis from a lens surface of the objective which is closest to the object side to a lens surface of the objective which is closest to the image side.

3. The objective according to claim 1, wherein the first lens group includes
a first lens component arranged closest to the object side, and
a meniscus lens.

4. The objective according to claim 3, wherein the first lens component is a cemented lens component in which a positive lens having a convex surface facing the image side and a meniscus lens having a concave surface facing the object side are cemented.

5. The objective according to claim 1, wherein the second lens group converts divergent pencils of rays into convergent pencils of rays.

6. The objective according to claim 1, wherein the second lens group is a three-lens cemented lens component including a biconvex lens, a biconcave lens, and a biconvex lens.

7. The objective according to claim 1, wherein
the fourth lens group includes two or more lens components, and
each of the two lens components included in the fourth lens group is a meniscus lens component having a concave surface facing the object side.

8. The objective according to claim 1, wherein
the objective is an immersion microscope objective, and
the objective satisfies the following conditional expression:
0.9≤NA×WD [mm]
here, NA denotes the numerical aperture of the immersion microscope objective on the object side, and WD denotes a working distance of the immersion microscope objective.

9. The objective according to claim 1, wherein the objective is an immersion microscope objective having a magnification of 30 times or lower.

10. The objective according to claim 2, wherein the first lens group includes a first lens component arranged closest to the object side, and a meniscus lens.

11. The objective according to claim 2, wherein the second lens group converts divergent pencils of rays into convergent pencils of rays.

12. The objective according to claim 2, wherein the second lens group is a three-lens cemented lens component including a biconvex lens, a biconcave lens, and a biconvex lens.

13. The objective according to claim 2, wherein
the fourth lens group includes two or more lens components, and
each of the two lens components included in the fourth lens group is a meniscus lens component having a concave surface facing the object side.

14. The objective according to claim 2, wherein
the objective is an immersion microscope objective, and
the objective satisfies the following conditional expression:
0.9≤NA×WD [mm]
here, NA denotes the numerical aperture of the immersion microscope objective on the object side, and WD denotes a working distance of the immersion microscope objective.

15. The objective according to claim 2, wherein the objective is an immersion microscope objective having a magnification of 30 times or lower.

16. The objective according to claim 3, wherein the second lens group converts divergent pencils of rays into convergent pencils of rays.

17. The objective according to claim 3, wherein the second lens group is a three-lens cemented lens component including a biconvex lens, a biconcave lens, and a biconvex lens.

18. The objective according to claim 3, wherein
the fourth lens group includes two or more lens components, and
each of the two lens components included in the fourth lens group is a meniscus lens component having a concave surface facing the object side.

19. The objective according to claim 3, wherein
the objective is an immersion microscope objective, and
the objective satisfies the following conditional expression:
0.9≤NA×WD [mm].

20. The objective according to claim 3, wherein the objective is an immersion microscope objective having a magnification of 30 times or lower.
